(19) United States
(12) Patent Application Publication
(10) Pub. No.: US 2003/0186211 A1
(43) Pub. Date: Oct. 2, 2003

(54) Training support program, application installation support program, and training support method

(75) Inventors: Kenichi Tadokoro, Kawasaki (JP); Yasuhiro Hirano, Kawasaki (JP); Kanako Kusunoki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/376,501

(22) Filed: Mar. 3, 2003

(30) Foreign Application Priority Data
Mar. 27, 2002 (JP) 2002-088565

(51) Int. Cl. G09B 3/00

(52) U.S. Cl. 434/350

(57) ABSTRACT

A training support program which permits individual participants in a seminar to practice installing an application program and at the same time to actually install the program in existing network environments of the respective participants' corporations. A terminal device used by a participant in the seminar is caused to display, in accordance with the progress of the seminar, an input screen for entering environment information matching the environment of a network in which the participant intends to install the network application (Step S1). Subsequently, a computer acquires the environment information entered by the participant into the terminal device following the training procedure of the seminar, to generate, based on the acquired environment information, individual environment setting information necessary for configuring an operational environment for the network application on the network (Step S2).

### BACKGROUND OF THE INVENTION

1. Field of the Invention

The present invention relates to a training support program, application installation support program and training support method for supporting training conducted in a network application installation seminar, and more particularly, to a training support program, application installation support program and training support method for supporting training with the use of a computer which is outside the network in which a network application is to be installed.

2. Description of the Related Art

With the advance of information technology, more and more corporations have come to introduce computer networks of their own. The introduction of a computer network permits efficient transaction of business and also facilitates the communication and collection of information.

To make good use of a computer network, a variety of application software packages designed for networks (hereinafter merely referred to as network applications) need to be installed in computers on the network. Installing a network application, however, requires an advanced knowledge of the computer network. For example, the knowledge of communication protocols, such as TCP/IP (Transmission Control Protocol/Internet Protocol), and network security is required. Without such knowledge, the computer network cannot be correctly configured or be operated stably. Especially, in the case of configuring a UNIX (registered trademark) server system, the know-how of system configuration is required.

Accordingly, corporations etc. that support computer network system configuration often hold seminars on the system configuration and operation accompanying the installation of network applications. Staff members of corporations who take charge of system configuration participate in such seminars so that they can learn the techniques necessary to install network applications.

For example, in an ordinary seminar, a simple system environment is prepared at the seminar site. Using a sample of environment information, the seminar participants edit the sample and set the environment information so as to match the environment prepared at the seminar site. This enables the seminar participants to configure the system in the simple environment created at the seminar site, in accordance with the network application to be installed.

However, after the seminar participants return to their corporations, they must configure systems in network environments different from that prepared at the seminar site. Configuring a system that operates normally in an existing environment in cooperation therewith is a difficult task, because the task requires a deep understanding of the make-up of the existing environment as well as the mechanisms of the techniques applied. Namely, with the conventional instruction method by means of a seminar, even though the participants practice introducing a system at the seminar, they must again install and configure the systems of their corporations after returning from the seminar, which consumes time and labor.

Moreover, there is no guarantee that the knowledge acquired from the seminar is comprehensive enough to correctly install a new network application on the existing networks of the respective corporations. Consequently, the system configuration consumes considerable time.

Large corporations that have been operating computer networks for many years have the know-how of computer system configuration. Accordingly, when a new network application is to be introduced, staff members may simply be sent to a new product installation seminar. Also, in the case of a large corporation, engineers specializing in computer networks may be employed to assign them the configuration and operation of computer networks. Thus, even if trouble occurs in the process of installation of a new network application, such engineers can analyze problems and remedy the trouble.

However, in the case of a medium- or small-sized corporation or private concern, it is not practical to assign the configuration and operation of a network system to a full-time engineer employed exclusively therefor. It is also difficult for such a small corporation and the like to spare a lot of time for the training of a person to make him/her master the expertise of network systems. Accordingly, there has been a demand for a seminar that enables people to learn methods of configuring systems matching the environments of their corporations.

### SUMMARY OF THE INVENTION

The present invention was created in view of the above circumstances, and an object thereof is to provide a training support program, application installation support program and training support method which permit individual participants in a seminar to practice installing an application program and at the same time to actually install the program in existing network environments of corporations to which the respective participants belong.

To achieve the object, there is provided a training support program for supporting training conducted in a network application installation seminar. The training support program causes a computer to perform a process of causing a terminal device used by a participant in the seminar to display, in accordance with progress of the seminar, an input screen for entering environment information matching an environment of a network in which the participant intends to install the network application, and acquiring the environment information entered by the participant into the terminal device following a training procedure of the seminar, to generate, based on the acquired environment information, individual environment setting information necessary for configuring an operational environment for the network application on the network.

Also, to achieve the above object, there is provided an application installation support program for installing a network application from a remote place. The application installation support program causes a computer to perform a process of causing a terminal device to display an input screen for entering environment information matching an environment of a network in which the network application is to be installed, acquiring the environment information entered into the terminal device to generate, based on the acquired environment information, individual environment setting information necessary for configuring an operational environment for the network application on the network, and accessing, through a different network, a server computer in the network in which the network application is to be installed, to store the individual environment setting information in the server computer.

Further, there is provided a training support method for supporting training conducted in a network application installation seminar with use of a computer. The training support method comprises causing a terminal device used by a participant in the seminar to display, in accordance with progress of the seminar, an input screen for entering environment information matching an environment of a network in which the participant intends to install the network application, and acquiring the environment information entered by the participant into the terminal device following a training procedure of the seminar, to generate, based on the acquired environment information, individual environment setting information necessary for configuring an operational environment for the network application on the network.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram illustrating the invention applied to embodiments;

FIG. 2 is a diagram illustrating an exemplary system configuration according to an embodiment of the present invention;

FIG. 3 is a diagram illustrating an exemplary hardware configuration of a seminar server used in the embodiment of the present invention;

FIG. 4 is a block diagram illustrating functions of the seminar server;

FIG. 5 is a diagram illustrating an exemplary data structure of a training common environment information table;

FIG. 6 is a diagram illustrating an exemplary data structure of a training individual environment information table;

FIG. 7 is a diagram illustrating an exemplary data structure of table item linkage rules;

FIG. 8 is a diagram illustrating an exemplary data structure of system configuration information templates;

FIG. 9 is a flowchart illustrating a procedure for carrying on a network configuration seminar;

FIG. 10 is the first half of a flowchart illustrating a procedure for an environment information input process;

FIG. 11 is the latter half of the flowchart illustrating the procedure for the environment information input process;

FIG. 12 is a diagram illustrating an example of a login screen;

FIG. 13 is a diagram illustrating an example of an environment setting basic information input screen;

FIG. 14 is a diagram illustrating an example of a Web environment information input screen;

FIG. 15 is a diagram illustrating an example of a proxy environment information input screen;

FIG. 16 is a diagram illustrating an example of a DNS environment information input screen;

FIG. 17 is a diagram illustrating an example of an access restriction setting screen;

FIG. 18 is a diagram illustrating an example of the training individual environment information table having individual data stored therein;

FIG. 19 is a flowchart illustrating a procedure for a user-specific environment setting table creation process;

FIG. 20 is a conceptual diagram illustrating an example of an inter-table item linkage process;

FIG. 21 is a diagram illustrating an exemplary data structure of a user-specific environment setting table;

FIG. 22 is a flowchart illustrating a procedure for a system configuration information generation process;

FIG. 23 is a conceptual diagram illustrating an example of an environment setting file generation process;

FIG. 24 is a diagram illustrating an exemplary data structure of computer ID-specific system configuration information;

FIG. 25 is a diagram illustrating an example of a Web server setting file;

FIG. 26 is a diagram illustrating an example of a mail server setting file;

FIG. 27 is a diagram illustrating a first example of a DNS server setting file;

FIG. 28 is a diagram illustrating a second example of the DNS server setting file;

FIG. 29 is a diagram illustrating a third example of the DNS server setting file;

FIG. 30 is a diagram illustrating an example of a proxy server setting file; and

FIG. 31 is a diagram illustrating an example of a Web server startup screen.

### DESCRIPTION OF THE PREFERRED EMBODIMENTS

Embodiments of the present invention will be hereinafter described with reference to the drawings.

First, the invention applied to the embodiments will be outlined, and then the embodiments will be described in detail.

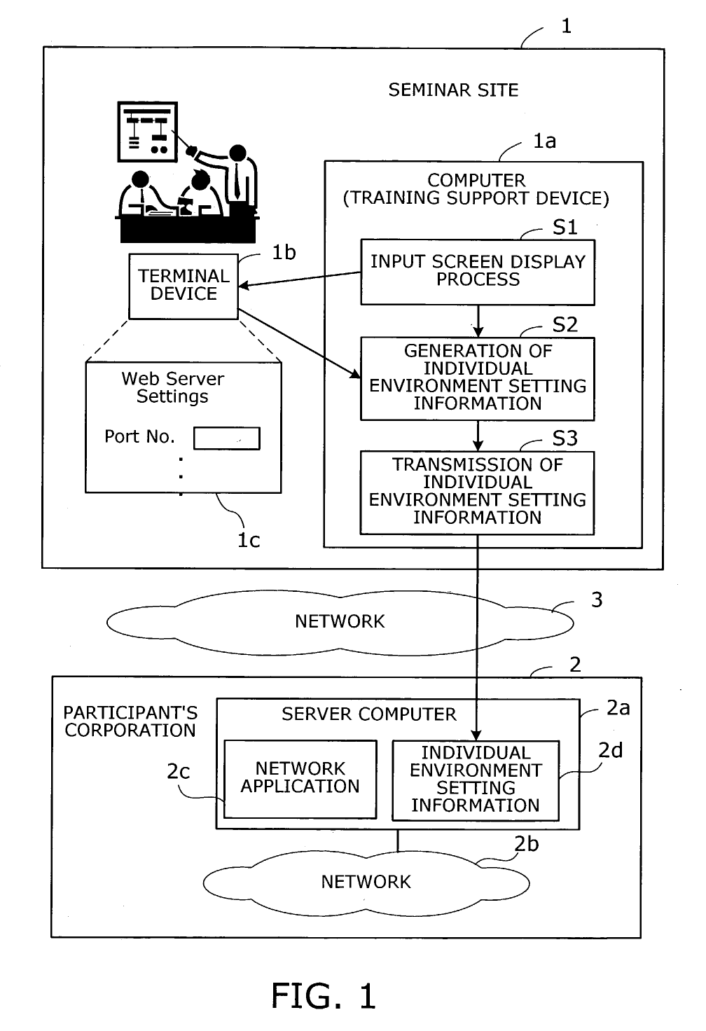

FIG. 1 illustrates the concept of the invention applied to the embodiments. The invention applied to the embodiments uses a computer 1a and a terminal device 1b, both arranged at a seminar site 1, to support training for the installation of a network application 2c in a server computer 2a in conformity with a network 2b of a corporation 2 to which a participant in the seminar belongs. A training support program according to the present invention is executed by the computer 1a, whereupon the processes described below are performed by the computer 1a. Also, when executing the training support program, the computer 1a functions as a training support device.

The computer 1a causes the terminal device 1b used by the seminar participant to display, in accordance with the progress of the seminar, an input screen 1c for entering environment information matching the environment of the network 2b in which the participant intends to install the network application 2c (Step S1).

Following the training procedure of the seminar, the participant inputs environment information to the terminal device 1b, whereupon the computer 1a acquires the environment information input to the terminal device 1b by the participant. Then, based on the acquired environment information, the computer 1a generates individual environment setting information 2d necessary for configuring an operational environment for the network application 2c on the network 2b (Step S2).

Subsequently, the computer 1a accesses, through a different network 3, the server computer 2a in the network 2b in which the participant intends to install the network application, and stores the individual environment setting information 2d in the server computer 2a (Step S3).

When the training support program is executed by the computer 1a, first, the environment information input screen 1c is displayed on the terminal device 1b. The participant inputs environment information to the terminal device 1b, whereupon the individual environment setting information 2d necessary for configuring the operational environment for the network application 2c to be installed is generated based on the environment information input to the terminal device 1b by the participant.

Accordingly, as the training of the seminar proceeds, the seminar participant can create the individual environment setting information 2d for the network 2b which the participant intends to configure, and can install the network application 2c in the server computer 2a in accordance with the individual environment setting information 2d.

The invention may be used in such a way that the networks of respective corporations, to which participants (customers) belong, are connected to the computer 1a (training support device) at the seminar site 1 through the Internet, whereby the seminar participants can install and configure the network application in the server computers of their respective corporations during the training conducted in the seminar. Namely, by the time the training ends, the system environment configuration can be completed so that the customers' computer systems may be ready for operation. Also, the invention permits the terminal device 1b at the seminar site 1 to carry out remote access to the server computer 2a of each corporation, so that up to the confirmation of operation and administration may be trained at the seminar.

As a consequence, the training of the participants (customers) in the seminar and the system configuration of their respective corporations progress simultaneously, and when the training ends, the systems of the respective corporations are ready for operation. This permits the corporations to cut down the manpower needed for the installation, administration, etc. of the network application and also to improve the quality of system configuration. Further, for the training corporation holding the seminar, training can be conducted using the customers' existing network environments, and it is therefore possible to efficiently provide services meeting the actual conditions, which leads to an increase of participants.

Embodiments of the invention will be now described with reference to an exemplary case where a new network system is introduced into computers of corporations to which participants in a network system configuration seminar belong, from the seminar site at a remote place.

In the following description of the embodiments, it is assumed that environments are configured for the server functions, such as a Web server, as the network application. Thus, the computer used as a server is referred to herein as server computer, and the server functions (Web server, mail server, etc.) configured on the computer are referred to merely as servers.

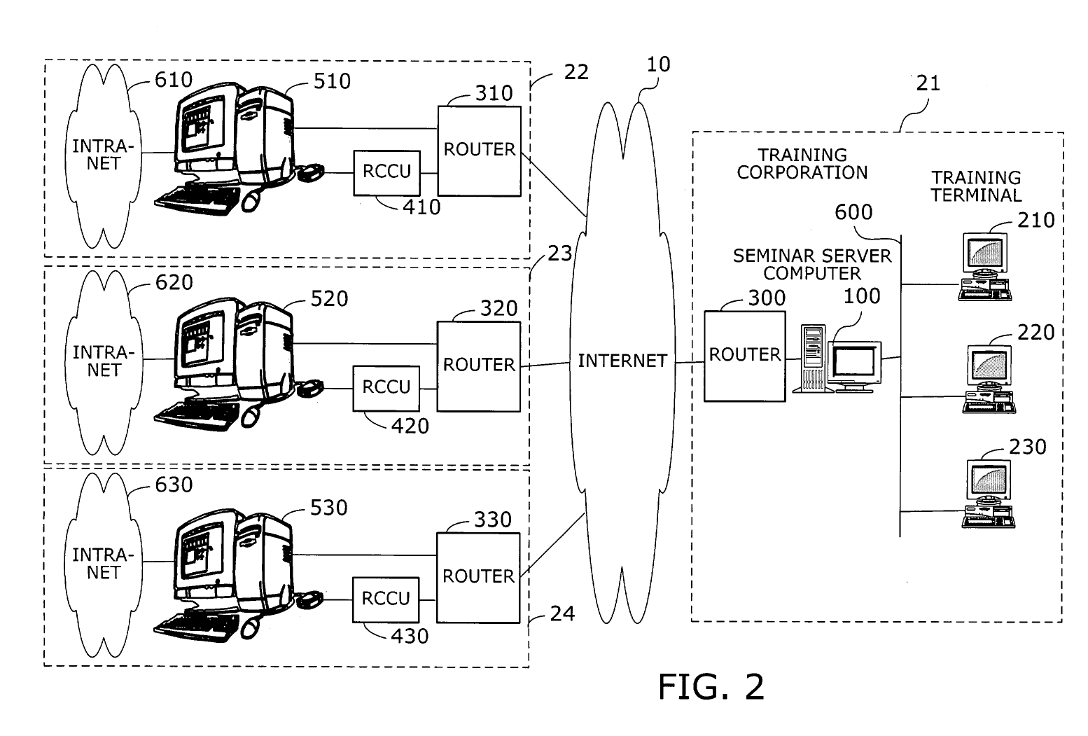

FIG. 2 shows an exemplary system configuration according to an embodiment of the present invention. As shown in FIG. 2, an intranet 600 is configured in a training corporation 21 which holds a seminar. Also, intranets 610, 620 and 630 are configured in respective corporations 22 to 24 to which seminar participants belong. The intranet 600 of the training corporation 21 and the intranets 610, 620 and 630 of the participants' corporations 22 to 24 are interconnected by the Internet 10.

In the training corporation 21, a seminar server computer 100 and a plurality of training terminals 210, 220 and 230 are connected to the intranet 600. The seminar server computer 100 is connected via a router 300 to the Internet 10.

The seminar server computer 100 transmits information (screen data for the seminar, etc.) necessary for the seminar to the training terminals 210, 220 and 230, and stores information transmitted from the training terminals 210, 220 and 230. Also, based on the information transmitted from the training terminals 210, 220 and 230, the seminar server computer 100 generates environment setting files for network system configuration. Further, the seminar server computer 100 can transfer the generated environment setting files to server computers 510, 520 and 530 arranged in the participants' corporations 22 to 24 through the Internet 10.

The training terminals 210, 220 and 230 each access the seminar server computer 100 to acquire the necessary information for the seminar, the acquired information being displayed on screen or output vocally. For example, each of the training terminals 210, 220 and 230 has a Web browser function for receiving an HTML (Hyper Text Markup Language) document from the seminar server computer 100 and displaying the document on the screen thereof and, when various information such as network environment information is input by the participant, transmits the input information to the seminar server computer 100.

Further, the training terminals 210, 220 and 230 have the function of carrying out remote access to other computers (e.g., the server computers 510, 520, 530). Such a function enabling remote access includes Telnet.

The router 300 takes charge of the routing of packets between the intranet 600 of the training corporation 21 and the Internet 10.

In the corporation 22, a corporate network is configured by means of a router 310, a remote console device (RCCU: Remote Console Connection Unit) 410, the server computer 510, and the intranet 610. The router 310 is connected to the Internet 10, the RCCU 410, and the server computer 510. The RCCU 410 is also connected to the server computer 510, which is connected also to the intranet 610.

The router 310 takes care of routing packets between the corporate network and the Internet 10. The RCCU 410 is a device that allows input/output of data between a console port (communication port to which the console terminal is connected) of the server computer 510 and a remote place. The RCCU 410 is connected to the console port of the server computer 510 and inputs a command etc. to the console port of the server computer 510 in compliance with a request from other computers (seminar server computer 100 or training terminal 210, 220, 230) connected thereto through the Internet 10. Also, the RCCU 410 transmits data output from the console port of the server computer 510 to other computers connected thereto through the Internet 10.

The server computer 510 is provided so as to manage the intranet 610 in the corporation 22. Application software is installed in the server computer 510, whereby the server computer can perform various network system-related functions. For example, the server computer 510 can be configured to function as a Web server, a mail server (SMTP server, POP server), a DNS server, etc.

In the corporation 23, a corporate network is configured by means of a router 320, an RCCU 420, the server computer 520, and the intranet 620. The connections and functions of these devices are identical with those of the respective devices constituting the network system of the corporation 22.

Also in the corporation 24, a corporate network is configured by means of a router 330, an RCCU 430, the server computer 530, and the intranet 630. The connections and functions of these devices are identical with those of the respective devices constituting the network system of the corporation 22.

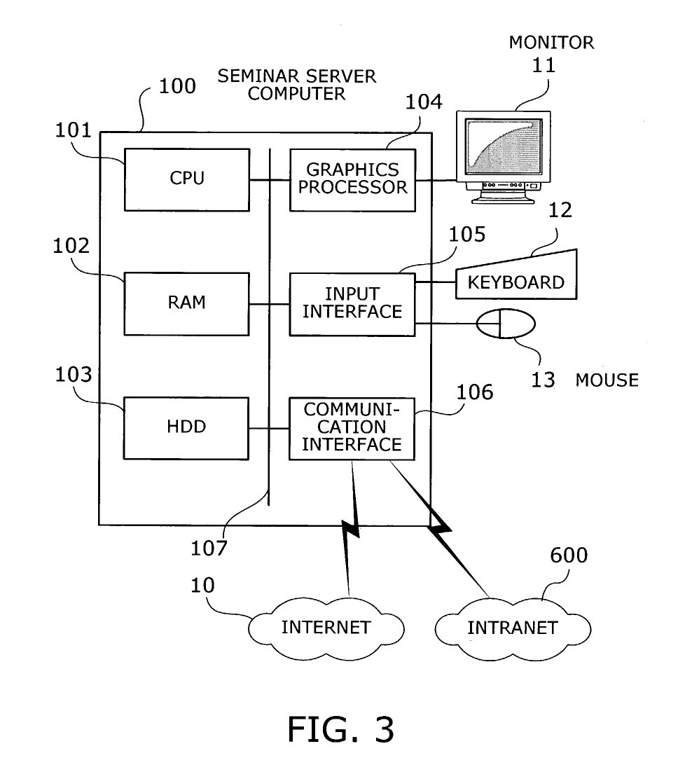

FIG. 3 shows an exemplary hardware configuration of the seminar server computer according to the embodiment of the present invention. The seminar server computer 100 is in its entirety under the control of a CPU (Central Processing Unit) 101. To the CPU 101 are connected, via a bus 107, a RAM (Random Access Memory) 102, a hard disk drive (HDD) 103, a graphics processor 104, an input interface 105, and a communication interface 106.

The RAM 102 temporarily stores OS (Operating System) programs and at least part of application programs executed by the CPU 101. The RAM 102 also stores various other data necessary for the processing by the CPU 101. The HDD 103 stores the OS and application programs.

The graphics processor 104 is connected to a monitor 11. In accordance with instructions from the CPU 101, the graphics processor 104 causes the monitor 11 to display images on the screen. The input interface 105 is connected to a keyboard 12 and a mouse 13. The input interface 105 sends signals received from the keyboard 12 and the mouse 13 to the CPU 101 through the bus 107.

The communication interface 106 is connected to the Internet 10 and the intranet 600. The communication interface 106 transmits and receives data to and from other computers through the Internet 10 or the intranet 600.

With the hardware configuration described above, the processing functions of the embodiment can be performed. Although in FIG. 3 the hardware configuration of the seminar server computer 100 is illustrated by way of example, the training terminals 210, 220 and 230 and the server computers 510, 520 and 530 may each have a similar hardware configuration.

The processing functions of the seminar server will be now described. In the following, for simplicity of explanation, the embodiment of the present invention will be described in detail with reference to an exemplary case where a person in charge of the administration of the network of the corporation 22 receives a training as a seminar participant by using the training terminal 210.

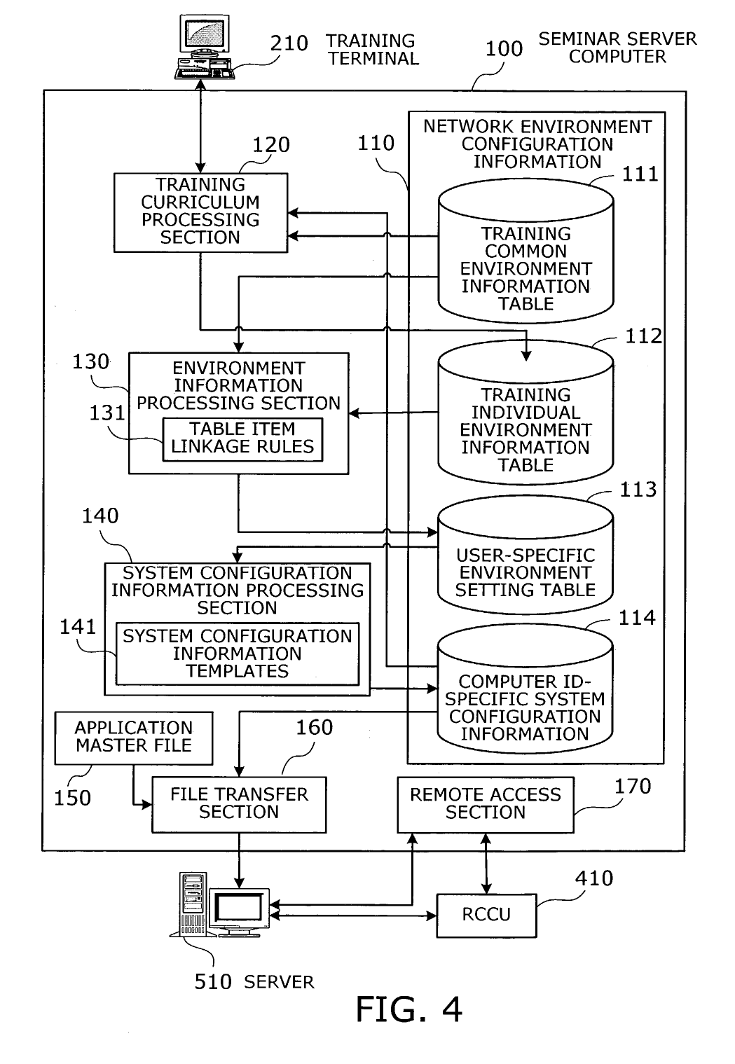

FIG. 4 is a block diagram illustrating the functions of the seminar server. The seminar server computer 100 has network environment configuration information 110, a training curriculum processing section 120, an environment information processing section 130, a system configuration information processing section 140, an application master file 150, a file transfer section 160, and a remote access section 170. The network environment configuration information 110 includes a training common environment information table 111, a training individual environment information table 112, a user-specific environment setting table 113, and computer ID-specific system configuration information 114. The environment information processing section 130 has table item linkage rules 131, and the system configuration information processing section 140 has system configuration information templates 141.

Among these elements, those between which information is exchanged are connected to each other. The connection mentioned here means that arrangement has been made to exchange information between the elements connected to each other. Specifically, the training curriculum processing section 120 is connected through the intranet 600 (shown in FIG. 2) to the training terminal 210, and is also connected to the training common environment information table 111, training individual environment information table 112 and computer ID-specific system configuration information 114 in the network environment configuration information 110. The environment information processing section 130 is connected to the training common environment information table 111, training individual environment information table 112 and user-specific environment setting table 113 in the network environment configuration information 110. The system configuration information processing section 140 is connected to the user-specific environment setting table 113 and computer ID-specific system configuration information 114 in the network environment configuration information 110. The file transfer section 160 is connected to the computer ID-specific system configuration information 114 in the network environment configuration information 110, as well as to the application master file 150. Also, the file transfer section 160 is connected through the Internet 10 (shown in FIG. 2) to the server computer 510. The remote access section 170 is connected through the Internet 10 to the RCCU 410 and the server computer 510.

The network environment configuration information 110 is information which the seminar participant uses to configure a system environment that matches the network environment of the participant's corporation.

The training common environment information table 111 is a data table storing environment information used in common by all participants in the seminar. For example, the table stores information such as a general user account that is at least necessary for employees etc. to log in to the server computers of the participants' corporations.

The training individual environment information table 112 is a data table storing information (environment information) about the network environments of the respective corporations to which the seminar participants belong. In the training individual environment information table 112, information is stored in association with each training terminal used by the participant. The information stored in the training individual environment information table 112 mainly includes information input by the participant using the training terminal 210 after the seminar begins.

The user-specific environment setting table 113 is a data table storing information (individual environment setting information) necessary for the environment setting when the network application is introduced into the participant's corporation. The user-specific environment setting table 113 is created based on the training common environment information table 111 and the training individual environment information table 112.

In the computer ID-specific system configuration information 114, an environment setting file necessary for introducing the network application into the participant's corporation is stored in association with identification information (ID) of the server computer of the corporation to which the seminar participant belongs. The environment setting file is created based on the user-specific environment setting table 113.

In response to a request from the training terminal 210, the training curriculum processing section 120 sends screen data necessary for the training sequentially to the training terminal 210 in accordance with the training curriculum. The screen data is, for example, an HTML document. Also, on receiving information about the network environment of the participant's corporation from the training terminal 210, the training curriculum processing section 120 stores the received information in the training individual environment information table 112.

Based on the information stored in the training common environment information table 111 and training individual environment information table 112, the environment information processing section 130 generates information to be stored in the user-specific environment setting table 113, in compliance with the table item linkage rules 131. Then, the environment information processing section 130 stores the generated information in the user-specific environment setting table 113. The table item linkage rules 131 have information generation rules set therein in conformity with which information to be stored in the user-specific environment setting table 113 is generated based on the information stored in the training common environment information table 111 and training individual environment information table 112.

The system configuration information processing section 140 looks up the system configuration information templates 141 and generates, based on the user-specific environment setting table 113, an environment setting file to be stored in the computer ID-specific system configuration information 114. The system configuration information processing section 140 then stores the generated environment setting file in the computer ID-specific system configuration information 114. The system configuration information templates 141 are a model or sample of the environment setting file.

The application master file 150 is a master file of the network application to be installed. With the application master file 150 specified, an installation program is started, whereby the network application can be installed in computers such as the server computer 510.

In response to an input operation by the user (participant or instructor of the seminar), the file transfer section 160 transfers the application master file 150 or the environment setting file stored in the computer ID-specific system configuration information 114 to the server computer 510.

The remote access section 170 performs remote access to the server computer 510 in response to an input operation by the user, to manipulate the server computer 510. The remote access section 170 can also access the server computer 510 through the RCCU 410, in which case the remote access section 170 can function as a console terminal of the server computer 510. With the function as the console terminal, the remote access section 170 can manipulate the server computer 510 even when the OS of the computer 510 is not started. (For example, it is possible to input a boot command etc. to the server computer 510 when the server computer is shut down and in monitor mode (in which the server computer operates in accordance with programs stored in the ROM).) A function similar to the remote access section 170 is also provided in each of the training terminals 210, 220 and 230. Thus, using the remote access function of the training terminals 210, 220 and 230, the seminar participants can manipulate the server computers 510, 520 and 530 of their respective corporations from a remote place.

Data structures of the information stored in the seminar server computer 100 will be now described. The contents of the user-specific environment setting table 113 and computer ID-specific system configuration information 114 are, however, generated sequentially as the participants input data after the start of the seminar, and accordingly, the data structures of such information will be explained following the description of processes performed prior to the generation of such information.

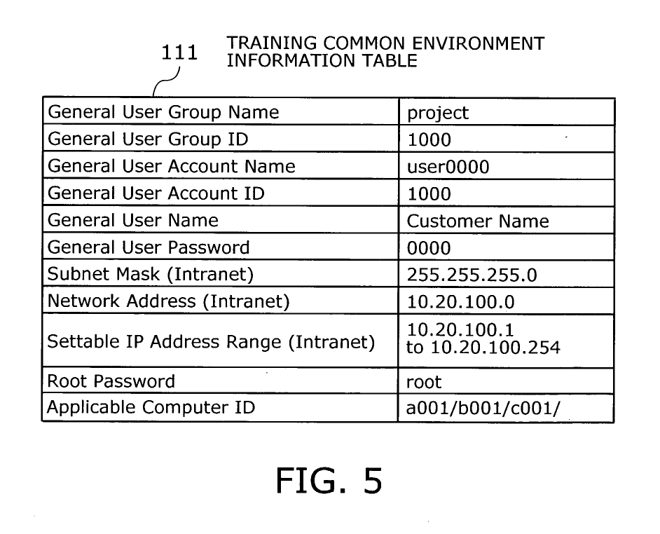

FIG. 5 illustrates an exemplary data structure of the training common environment information table. In the training common environment information table 111, environment information used in common by the seminar participants is registered. In this embodiment, the training common environment information table 111 has the following data registered therein.

The item “General User Group Name” indicates the group name of an account used to log in to the server computer of the participant's corporation. In the example of FIG. 5, “project” is registered under the item “General User Group Name.”

The item “General User Group ID” indicates the group ID (identification information) of the account used to log in to the server computer of the participant's corporation. In the example of FIG. 5, “1000” is registered under the item “General User Group ID.”

The item “General User Account Name” indicates the name of the account used to login in to the server computer of the participant's corporation. In the example of FIG. 5, “user0000” is registered under the item “General User Account Name.”

The item “General User Account ID” indicates the ID (identification information) of the account used to log in to the server computer of the participant's corporation. In the example of FIG. 5, “1000” is registered under the item “General User Account ID.”

The item “General User Name” indicates the name set with respect to the account used to log in to the server computer of the participant's corporation. In the example of FIG. 5, “Customer Name” is registered under the item “General User Name.”

The item “General User Password” indicates the password for the account used to log in to the server computer of the participant's corporation. In the example of FIG. 5, “0000” is registered under the item “General User Password.”

The item “Subnet Mask (Intranet)” indicates a subnet mask (mask value used when obtaining the network address of a subnet from an IP address) for the intranet in the participant's corporation. In the example of FIG. 5, “255.255.255.0” is registered under the item “Subnet Mask.”

The item “Network Address (Intranet)” indicates the network address of the server computer in the intranet of the participant's corporation. In the example of FIG. 5, “10.20.100.0” is registered under the item “Network Address.”

The item “Settable IP Address Range (Intranet)” indicates a settable range of IP address within which IP addresses can be assigned to other computers when the computers are connected to the intranet of the participant's corporation. In the example of FIG. 5, “10.20.100.1 to 10.20.100.254” is registered under the item “Settable IP Address Range (Intranet).”

The item “Root Password” indicates the password for the system administrator. In the example of FIG. 5, “root” is registered under the item “Root Password.”

The item “Applicable Computer ID” indicates the computer IDs assigned to the server computers 510, 520 and 530 of the respective participants' corporations. In the example of FIG. 5, “a001/b001/c001” is registered under the item “Applicable Computer ID.” Thus, in this embodiment, the server computer 510 has the computer ID “a001,” the server computer 520 has the computer ID “b001,” and the server computer 530 has the computer ID “c001.”

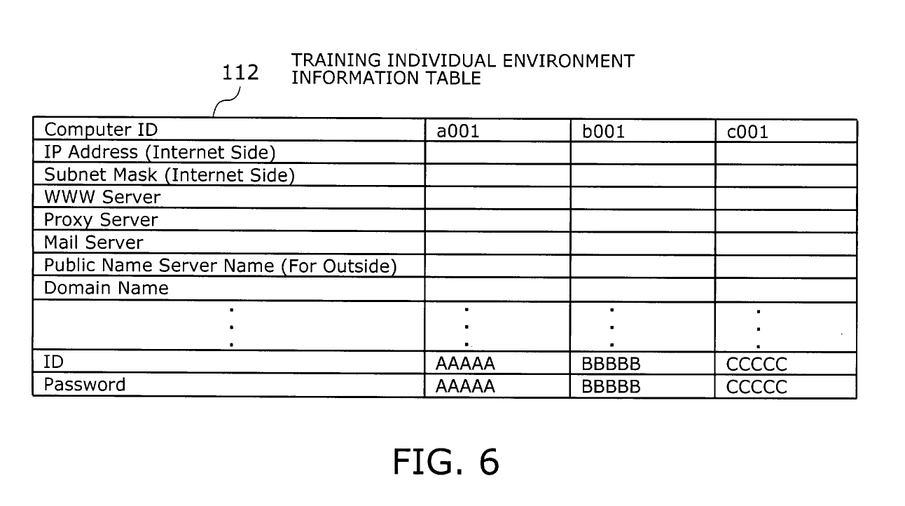

FIG. 6 illustrates an exemplary data structure of the training individual environment information table. The training individual environment information table 112 shown in FIG. 6 is in an initial state (state before the start of the seminar). Fields which are blank in the initial state are set with data that is entered by the participants after the seminar begins. In this embodiment, the training individual environment information table 112 has the following data registered therein.

The item “Computer ID” indicates the identification information of each of the server computers 510, 520 and 530. In the example of FIG. 6, “a001,” “b001” and “c001” are set under the item “Computer ID.” A column of data under “a001” constitutes data necessary for the environment setting of the server computer 510. Similarly, a column of data under “b001” constitutes data necessary for the environment setting of the server computer 520, and a column of data under “c001” constitutes data necessary for the environment setting of the server computer 530.

The item “IP Address (Internet Side)” indicates an IP address by means of which the server computer of the participant's corporation is connected to the Internet 10. In the initial state, the fields under the item “IP Address (Internet Side)” are blank.

The item “Subnet Mask (Internet Side)” indicates a subnet mask for connecting the server computer of the participant's corporation to the Internet 10. In the initial state, the fields under the item “Subnet Mask (Internet Side)” are blank.

The item “WWW Server” indicates the server name of a Web server (WWW server). In the initial state, the fields under the item “WWW Server” are blank.

The item “Proxy Server” indicates the server name of a proxy server. In the initial state, the fields under the item “Proxy Server” are blank.

The item “Mail Server” indicates the server name of a mail server. In the initial state, the fields under the item “Mail Server” are blank.

The item “Public Name Server Name (For Outside)” indicates the server name of a server which provides name resolution service for communications through the Internet 10. In the initial state, the fields under the item “Public Name Server Name (For Outside)” are blank.

The item “Domain Name” indicates a domain name of the server computer arranged in the corporation to which the seminar participant belongs. In the initial state, the fields under the item “Domain Name” are blank.

The item “ID” indicates the ID of an account used by the seminar participant to log in to the seminar server computer 100. In the example of FIG. 6, the ID “AAAAA” is set for the computer ID “a001.” The ID “BBBBB” is set for the computer ID “b001,” and the ID “CCCCC” is set for the computer ID “c001.”

The item “Password” indicates the password for the account used by the seminar participant to log in to the seminar server computer 100. In the example of FIG. 6, the password “AAAAA” is set for the computer ID “a001,” the password “BBBBB” is set for the computer ID “b001,” and the password “CCCCC” is set for the computer ID “c001.”

The IDs and passwords that allow the respective seminar participants to log in to the seminar server computer 100 are registered beforehand in the training individual environment information table 112 by the instructor. Also, before the seminar is held, documents showing the IDs and the passwords are mailed to the participants (Alternatively, documents including the IDs and the passwords may be sent by electronic mail).

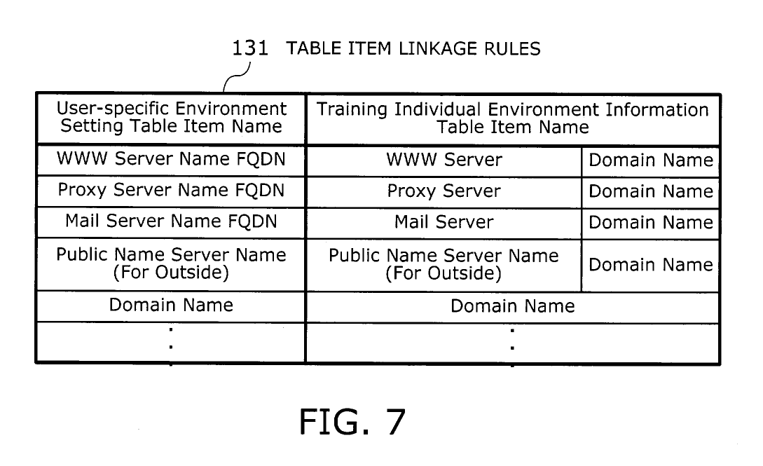

FIG. 7 illustrates an exemplary data structure of the table item linkage rules. The table item linkage rules 131 are provided with fields for the user-specific environment setting table item name and fields for the training individual environment information table item name. Pieces of information in each row are associated with one another.

In the fields under the user-specific environment setting table item name, the names of items to be additionally registered in the user-specific environment setting table 113 are registered.

In the fields under the training individual environment information table item name, one or more item names in the training individual environment information table 112 are registered as a source of generation of the items to be additionally registered in the user-specific environment setting table 113. In cases where a plurality of item names are registered under the training individual environment information table item name, data in the individual fields are extracted in order of registration (in FIG. 7, from left to right) and are linked together. The data thus linked together constitutes data for the item to be newly registered in the user-specific environment setting table 113.

In the example of FIG. 7, data for the user-specific environment setting table item name “WWW (World Wide Web) Server Name FQDN (Fully Qualified Domain Name)” is obtained by linking together the data with the training individual environment information table item names “WWW Server” and “Domain Name.” Data for the user-specific environment setting table item name “Proxy Server Name FQDN” is obtained by linking together the data with the training individual environment information table item names “Proxy Server” and “Domain Name.” Data for the user-specific environment setting table item name “Mail Server Name FQDN” is obtained by linking together the data with the training individual environment information table item names “Mail Server” and “Domain Name.” Data for the user-specific environment setting table item name “Public Name Server Name (For Outside)” is obtained by linking together the data with the training individual environment information table item names “Public Name Server Name (For Outside)” and “Domain Name.” Data for the user-specific environment setting table item name “Domain Name” is obtained from the data with the training individual environment information table item name “Domain Name.”

The table item linkage rules 131 described above are defined in the environment information processing section 130. In compliance with the table item linkage rules 131, the environment information processing section 130 can add items to the user-specific environment setting table 113.

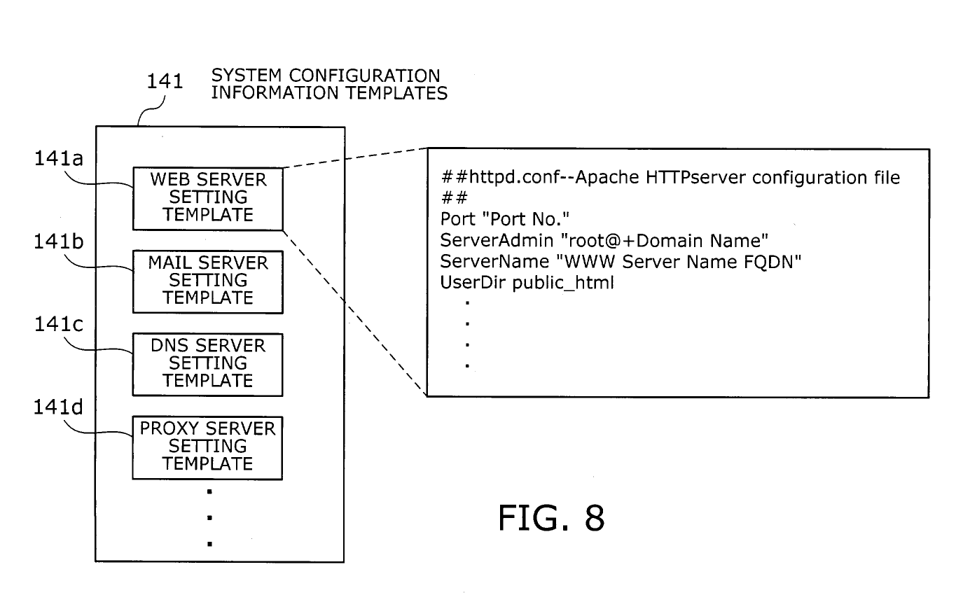

FIG. 8 illustrates an exemplary data structure of the system configuration information templates. The system configuration information templates 141 include, for example, a Web server setting template 141a, a mail server setting template 141b, a DNS (Domain Name System) server setting template 141c, a proxy server setting template 141d, etc. The Web server setting template 141a is a template for a file necessary for the environment setting when a Web server is installed. The mail server setting template 141b is a template for a file necessary for the environment setting when a mail server is installed, and the DNS (Domain Name System) server setting template 141c is a template for a file necessary for the environment setting when a DNS server is installed. The proxy server setting template 141d is a template for a file necessary for the environment setting when a proxy server is installed.

The individual templates have defined therein the names of variables to be registered in the respective environment setting files and values to be set as the variables. Among the variables, those which can be used in common by the seminar participants are previously set in the template files. For those variables (undefined elements) of which the values vary depending on the existing networks of the individual participants' corporations, corresponding item names in the user-specific environment setting table 113 are set. In FIG. 8, such undefined elements are indicated by enclosing item names in the user-specific environment setting table 113 by double quotation marks (“)

For example, the Web server setting template 141a shows that, for the variable “Port,” the data with the item name “Port No.” in the user-specific environment setting table 113 is set following “root@.” “root@” is an item (common item) set in common for all participants in the seminar, and thus is defined beforehand in the Web server setting template 141a.

For the variable “ServerAdmin,” the data with the item name “Domain Name” in the user-specific environment setting table 113 is set following “root@.” Further, for the variable “ServerName” is set the data with the item name “WWW Server Name FQDN” in the user-specific environment setting table 113.

By using the system configuration information templates 141 described above, the system configuration information processing section 140 can generate environment setting files to be stored in the computer ID-specific system configuration information 114.

The following is a detailed description of a procedure for carrying on a network configuration seminar according to the embodiment and a process executed by the seminar server computer 100 in accordance with the progress of the seminar.

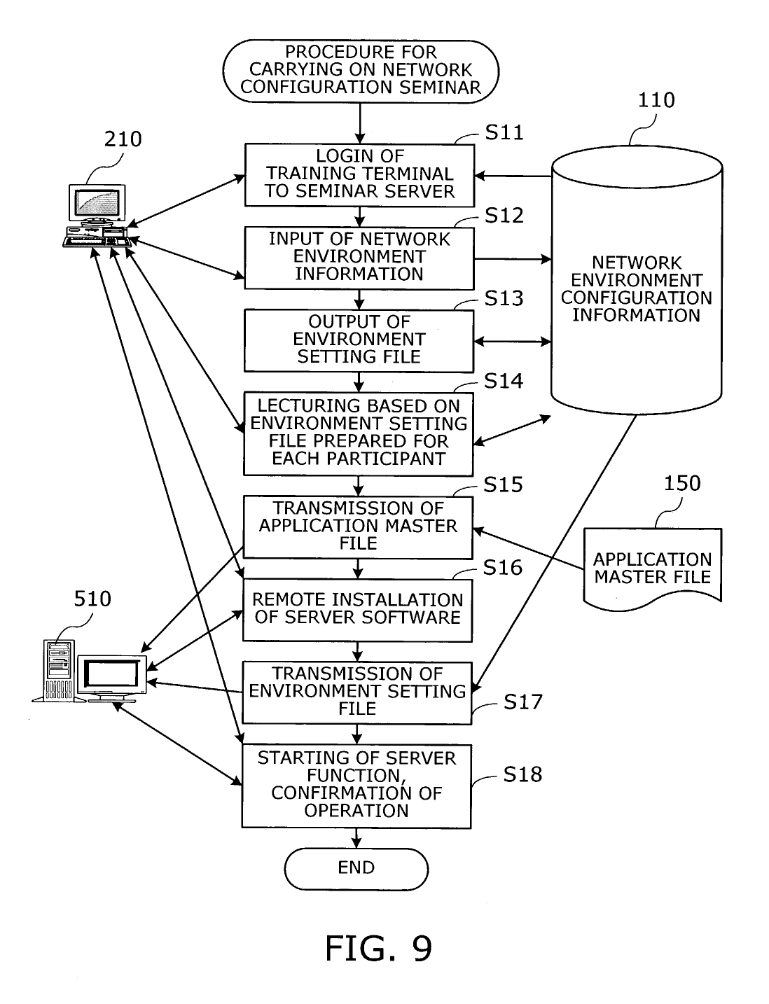

FIG. 9 is a flowchart illustrating the procedure for carrying on the network configuration seminar. The process shown in FIG. 9 will be now described in order of step number, with reference to an exemplary case where the training is conducted with the use of the training terminal 210 to configure a network system on the server computer 510 of the corporation 22.

[Step S11] The participant operates the training terminal 210 to log in to the seminar server computer 100. At this time, the training curriculum processing section 120 of the seminar server computer 100 looks up the training individual environment information table 112 in the network environment configuration information 110, to authenticate the user based on the account information (user name, password).

[Step S12] If the login is successful, the participant operates the training terminal 210 to input network environment information to the seminar server computer 100. The network environment information input at this time is information about the network environment of the corporation 22 to which the participant belongs. The network environment information is input in conformity with an environment information input screen which is supplied to the training terminal 210 from the training curriculum processing section 120 of the seminar server computer 100. On receiving the environment information, the training curriculum processing section 120 of the seminar server computer 100 stores the received environment information in the training individual environment information table 112 in the network environment configuration information 110.

[Step S13] On completion of the entry of the environment information, the environment information processing section 130 of the seminar server computer 100 generates the user-specific environment setting table 113 based on the training common environment information table 111 and training individual environment information table 112 in the network environment configuration information 110. Further, based on the user-specific environment setting table 113, the system configuration information processing section 140 generates an environment setting file for each computer ID, and outputs the file to the network environment configuration information 110 as the computer ID-specific system configuration information 114.

[Step S14] While performing input operation etc. with respect to the seminar server computer 100, the instructor of the seminar proceeds with the seminar on the basis of the environment setting file stored in the network environment configuration information 110. In this case, the training curriculum processing section 120 transmits the environment setting file in the computer ID-specific system configuration information 114 to the training terminal 210, whereupon the contents of the received environment setting file are displayed on the training terminal 210. Accordingly, the seminar participant can listen to the instructor while viewing the contents displayed on the training terminal 210, so that the participant can receive the seminar based on the environment setting file that matches the network of the corporation 22 to which the participant belongs.

[Step S15] After a lecture on environment setting etc. ends, the participant or the instructor inputs a transmission request to the seminar server computer 100 to request transmission of the application master file 150 to the server computer 510 of the participant's corporation 22. Thereupon, the seminar server computer 100 transmits the application master file 150 to the server computer 510 in the corporation 22. The application master file 150 is transmitted by a transfer method complying with FTP (File Transfer Protocol), for example. The application master file 150 thus transmitted is received by the server computer 510 and stored in a predetermined location thereof.

[Step S16] The participant operates the training terminal 210 to carry out remote access to the server computer 510. Then, the participant inputs, to the server computer 510, an installation instruction specifying the application master file 150 stored in the server computer 510. Thereupon, based on the application master file 150, the server computer 510 performs a process for installing a network application such as a Web server and a mail server, for example. During the installation of the application, the server computer 510 may send inquiry about settings to the training terminal 210. In such cases, the participant inputs default values (values set beforehand as initial values) to the training terminal 210. As a consequence, application software having a default environment setting file is installed in the server computer 510.

Also, during the installation of the application software, the OS of the server computer 510 may need to be restarted. In such cases, the participant accesses the server computer 510 from the training terminal 210 through the RCCU 410. This permits an interactive input operation, such as the input of a boot command, with respect to the server computer 510 which is in monitor mode, with the use of the training terminal 210. In response to the boot command, the server computer 510 starts to reload the OS.

[Step S17] In response to an input operation by the instructor or the participant, the seminar server computer 100 transmits the environment information file stored in the computer ID-specific system configuration information 114 to the server computer 510. The server computer 510 stores, in a predetermined location thereof, the environment information file transmitted from the seminar server computer 100. A default environment information file created at the time of installation may already be stored in the storage location. In this case, the server computer 510 stores the environment information file transmitted from the seminar server computer 100, by writing it over the environment information file already stored.

[Step S18] Using the training terminal 210, the participant carries out remote access to the server computer 510, to confirm operation such as by starting and running the installed server functions, etc.

In this manner, while receiving the seminar at the training corporation 21, the participant can install network application software in the server computer 510 of the corporation 22 to which the participant belongs, and also can make environment setting and confirmation of operation. If the participant has trouble with environment setting or the like, he/she can ask a question of the seminar instructor and can solve the problem quickly.

The process shown in FIG. 9 will be now described in more detail.

First, an example of input operation by the participant, performed in Steps S11 and S12, will be explained. In this example, it is assumed that the participant receives a seminar on the method of configuring a Web server and a mail server and at the same time installs such servers in the server computer of the corporation to which the participant belongs.

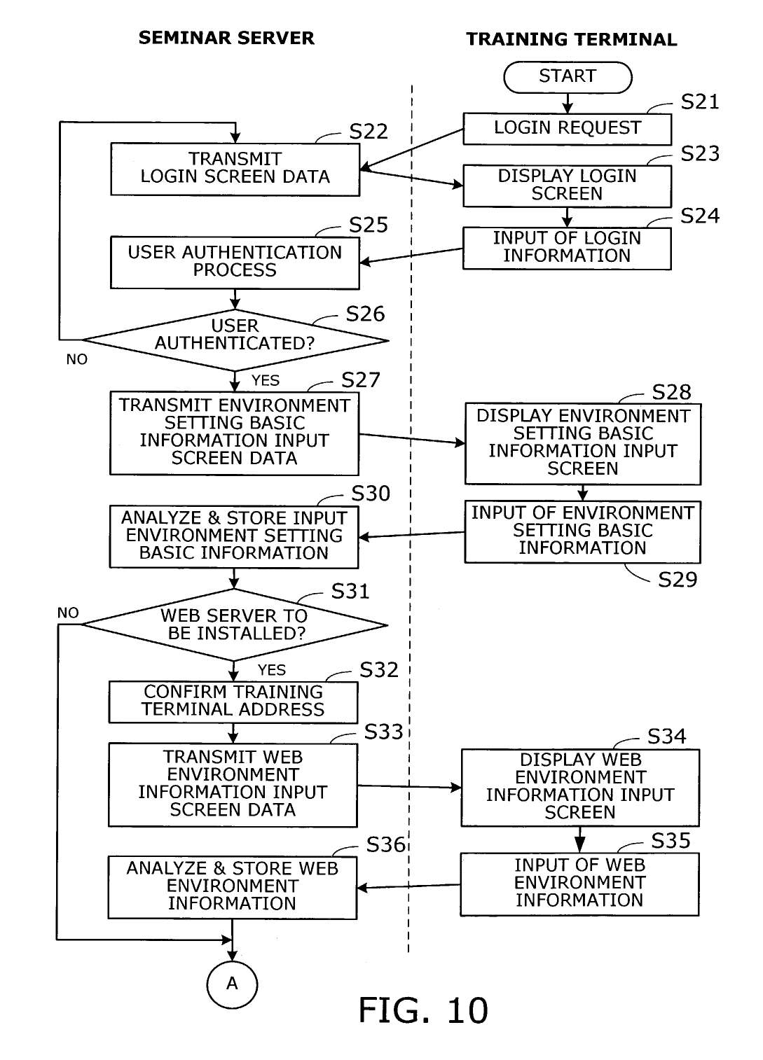

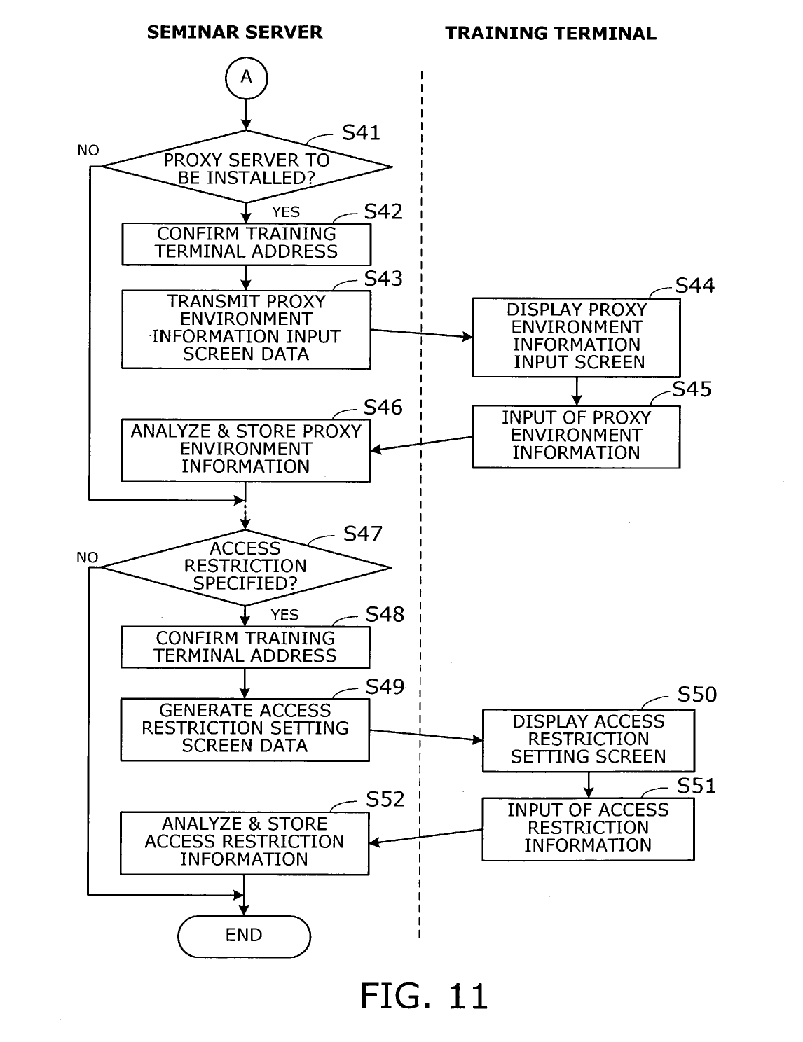

FIG. 10 is the first half of a flowchart showing the procedure for an environment information input process. In the following, the process shown in FIG. 10 will be explained in order of step number.

[Step S21] In response to an input operation by the participant, the training terminal 210 transmits a login request to the seminar server computer 100.

[Step S22] In compliance with the login request from the training terminal 210, the training curriculum processing section 120 of the seminar server computer 100 transmits login screen data to the training terminal 210.

[Step S23] The training terminal 210 displays a login screen in accordance with the login screen data transmitted from the seminar server computer 100.

[Step S24] The training terminal 210 accepts the participant's entry of data in login information input items (user name and password) provided in the login screen. Then, the training terminal 210 transmits the input login information to the seminar server computer 100.

[Step S25] Based on the login information transmitted from the training terminal 210, the training curriculum processing section 120 performs a user authentication process. Specifically, the training curriculum processing section 120 carries out user authentication by comparing the received login information with the account information (“ID” and “Password”) set in the training individual environment information table 112 to determine whether the two coincide or not.

[Step S26] The training curriculum processing section 120 determines whether or not the user is authenticated as a result of the user authentication. If the user is authenticated, the process proceeds to Step S27; if the user is not authenticated, the process proceeds to Step S22, whereupon the login process (Steps S22 to S25) is again repeated.

[Step S27] The training curriculum processing section 120 transmits environment setting basic information input screen data to the training terminal 210.

[Step S28] The training terminal 210 displays an environment setting basic information input screen in accordance with the environment setting basic information input screen data transmitted from the seminar server computer 100.

[Step S29] The training terminal 210 accepts the participant's entry of data in environment setting basic information input items (type of network application to be installed, etc.) provided in the environment setting basic information input screen. Then, the training terminal 210 transmits the input environment setting basic information to the seminar server computer 100.

[Step S30] The training curriculum processing section 120 analyzes the input environment setting basic information and stores the information in the RAM 102 or the like. The analysis of the input environment setting basic information includes identifying item names corresponding to the input information, for example.

[Step S31] The training curriculum processing section 120 determines whether or not “Web” (Web server) is selected in the environment setting basic information as a server (network application software) to be installed. If “Web” is selected, the process proceeds to Step S32; if not, the process proceeds to Step S41 in FIG. 11.

[Step S32] The training curriculum processing section 120 confirms the IP address of the training terminal 210 used by the participant.

[Step S33] The training curriculum processing section 120 transmits Web environment information input screen data to the training terminal 210.

[Step S34] The training terminal 210 displays a Web environment information input screen in accordance with the Web environment information input screen data received from the seminar server computer 100.

[Step S35] The training terminal 210 accepts the participant's entry of data in Web environment information input items provided in the Web environment information input screen. Then, the training terminal 210 transmits the input Web environment information to the seminar server computer 100.

[Step S36] The training curriculum processing section 120 of the seminar server computer 100 analyzes the Web environment information transmitted from the training terminal 210, and stores the Web environment information in the training individual environment information table 112. Subsequently, the process proceeds to Step S41 in FIG. 11.

FIG. 11 is the latter half of the flowchart showing the procedure for the environment information input process. In the following, the process shown in FIG. 11 will be explained in order of step number.

[Step S41] The training curriculum processing section 120 of the seminar server computer 100 determines whether or not “Proxy” (proxy server) is selected in the environment setting basic information as a server (network application software) to be installed. If “Proxy” is selected, the process proceeds to Step S42. If “Proxy” is not selected, steps similar to Steps S31 to S36 are executed with respect to “DNS” (name server), “Mail” (mail server), “Firewall” (firewall), “FTP” (FTP server) and “Telnet” (TELNET server), and then the process proceeds to Step S47.

[Step S42] The training curriculum processing section 120 confirms the IP address of the training terminal 210 used by the participant.

[Step S43] The training curriculum processing section 120 transmits proxy environment information input screen data to the training terminal 210.

[Step S44] The training terminal 210 displays a proxy environment information input screen in accordance with the proxy environment information input screen data received from the seminar server computer 100.

[Step S45] The training terminal 210 accepts the participant's entry of data in proxy environment information input items provided in the proxy environment information input screen. Then, the training terminal 210 transmits the input proxy environment information to the seminar server computer 100.

[Step S46] The training curriculum processing section 120 of the seminar server computer 100 analyzes the proxy environment information transmitted from the training terminal 210, and stores the proxy environment information in the training individual environment information table 112. Subsequently, steps similar to Steps S31 to S36 are executed with respect to “DNS” (name server), “Mail” (mail server), “Firewall” (firewall), “FTP” (FTP server) and “Telnet” (TELNET server), and the process proceeds to Step S47.

[Step S47] The training curriculum processing section 120 determines whether or not access restriction is specified in access restriction specification information included in the environment setting basic information. If access restriction is specified, the process proceeds to Step S48; if not, the process is ended.

[Step S48] The training curriculum processing section 120 confirms the IP address of the training terminal 210 used by the participant.

[Step S49] The training curriculum processing section 120 generates access restriction setting screen data including a schematic diagram of the network of the corporation (customer corporation) to which the participant belongs. Then, the training curriculum processing section 120 transmits the generated access restriction setting screen data to the training terminal 210.

[Step S50] The training terminal 210 displays an access restriction setting screen in accordance with the access restriction setting screen data received from the seminar server computer 100.

[Step S51] The training terminal 210 accepts the participant's selection of access restriction information selection items provided in the access restriction setting screen. Then, the training terminal 210 transmits the selected access restriction information to the seminar server computer 100.

[Step S52] The training curriculum processing section 120 of the seminar server computer 100 analyzes the access restriction information transmitted from the training terminal 210, and stores the access restriction information in the training individual environment information table 112, whereupon the process is ended.

In accordance with the procedure described above, the participant's entry of environment information about the network of the corporation to which the participants belongs is accepted and the input information is registered in the training individual environment information table 112.

The following describes examples of screens displayed at the training terminal 210 for the entry of environment information. It is assumed herein that the training terminal 210 is used for training by an engineer sent from the corporation 22.

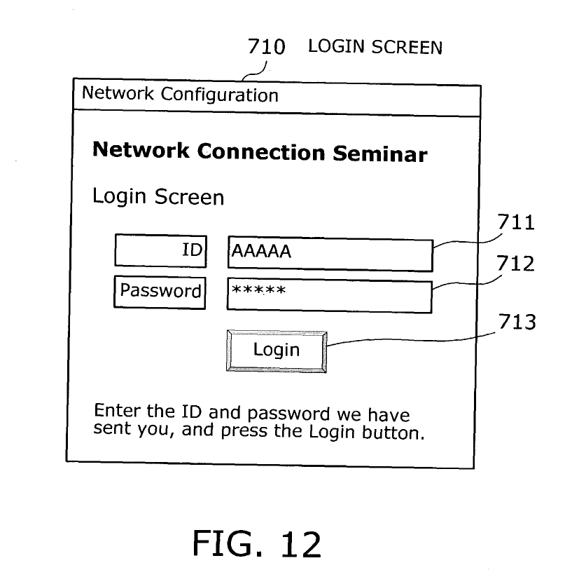

FIG. 12 illustrates an example of the login screen. The login screen 710 is provided with an ID input part 711, a password input part 712, and a Login button 713.

The ID input part 711 is a textbox for the entry of the ID of an account for logging in to the seminar server computer 100. In the example of FIG. 12, “AAAAA” is entered in the ID input part 711.

The password input part 712 is a textbox for the entry of the password of the account for logging in to the seminar server computer 100. In the example of FIG. 12, “AAAAA” is entered in the password input part 712, but “*****” is shown on screen.

The Login button 713 is used after the entry of the ID and the password for login, to determine the login information and transmit same to the seminar server computer 100. When the Login button 713 is pressed, the login information then entered in the ID input part 711 and the password input part 712 is transmitted to the seminar server computer 100.

If the login information coincides with the set of the ID and password registered beforehand in the training individual environment information table 112, the screen of the training terminal 210 switches to the environment setting basic information input screen.

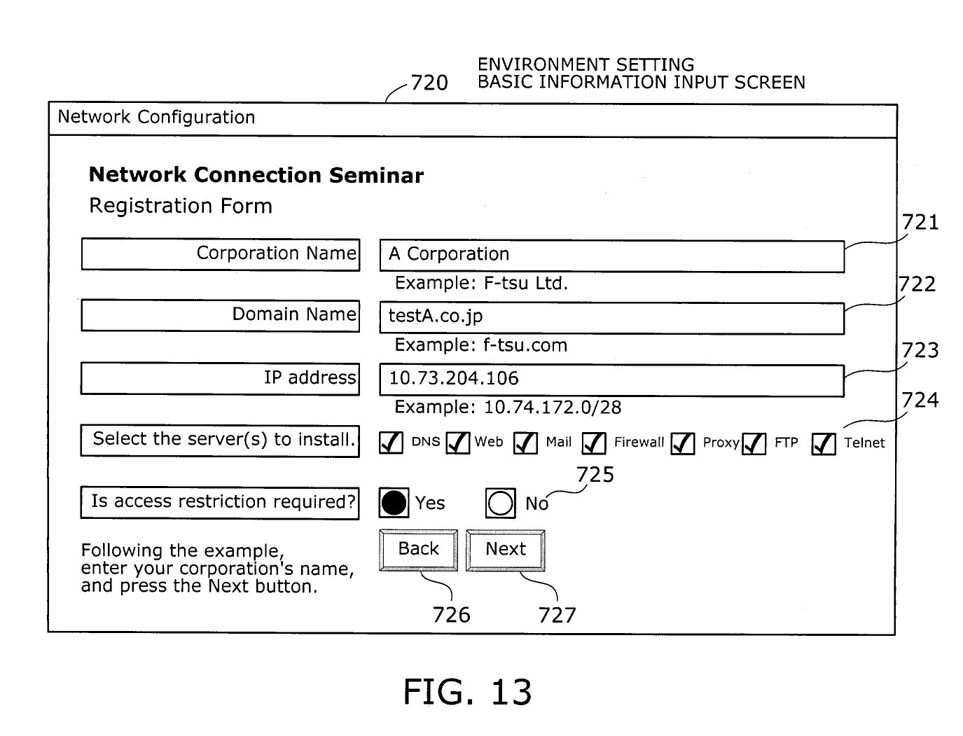

FIG. 13 illustrates an example of the environment setting basic information input screen. The environment setting basic information input screen 720 is provided with a corporation name input part 721, a domain name input part 722, an IP address input part 723, a configuring server selection checkbox group 724, access restriction selection radio buttons 725, a Back button 726, and a Next button 727.

The corporation name input part 721 is a textbox for the entry of the name of the corporation 22 to which the seminar participant belongs. In the example of FIG. 13, “A Corporation” is entered in the corporation name input part 721.

The domain name input part 722 is a textbox for the entry of the domain name of the server computer 510 of the corporation 22 to which the seminar participant belongs. In the example of FIG. 13, “testA.co.jp” is entered in the domain name input part 722.

The IP address input part 723 is a textbox for the entry of the IP address of the server computer 510 of the corporation 22 to which the seminar participant belongs. In the example of FIG. 13, “10.73.204.106” is entered in the IP address input part 723.

The configuring server selection checkbox group 724 includes a plurality of checkboxes for selecting a server or servers (network application software) to be installed in the server computer 510 of the corporation 22 to which the seminar participant belongs. The checkbox group 724 consists of checkboxes associated with DNS, Web, Mail, Firewall, Proxy, FTP, and Telnet, respectively. A checkmark is shown inside the selected checkbox. In the example of FIG. 13, all checkboxes are selected.

The access restriction selection radio buttons 725 are radio buttons for specifying whether access restriction is to be effected or not, and include a Yes button for specifying that access restriction is to be effected, and a No button for specifying that no access restriction is to be effected. A black dot appears only in the selected button. In the example of FIG. 13, the Yes button is selected.

The Back button 726 is used to reserve the settings in the environment setting basic information input screen 720 and to switch the screen to the previous screen (login screen 710). If the Back button 726 is pressed, the screen of the training terminal 210 switches to the login screen 710, without the environment setting basic information being transmitted to the seminar server computer 100.

The Next button 727 is used to determine the settings in the environment setting basic information input screen 720 and to transmit the environment setting basic information to the seminar server computer 100. If the Next button 727 is pressed, environment setting basic information is generated in accordance with the contents of data input in the environment setting basic information input screen 720 and transmitted to the seminar server computer 100.

The environment setting basic information is received by the seminar server computer 100, whereupon the training curriculum processing section 120 analyzes the contents of the environment setting basic information and recognizes, as a result, the types of servers selected in the configuring server selection checkbox group 724. Then, the training curriculum processing section 120 generates environment information input screen data for each of the selected server types, and transmits the generated data to the training terminal 210. According to the processing procedure shown in FIG. 10, the Web environment information input screen data is transmitted first, whereupon the Web environment information input screen is displayed on the screen of the training terminal 210.

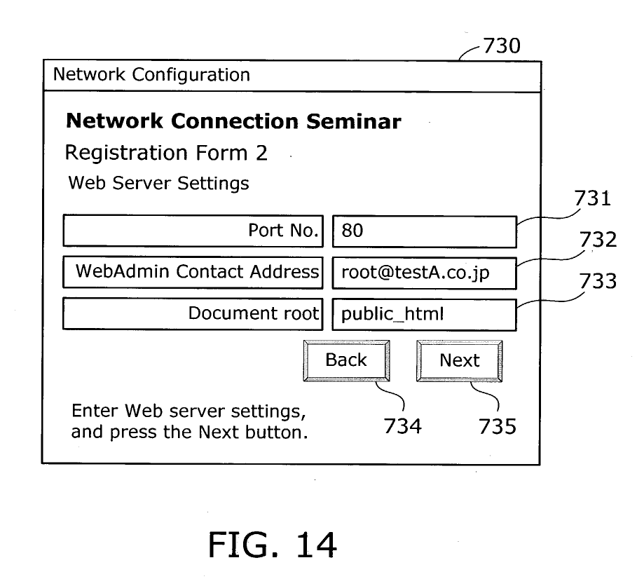

FIG. 14 illustrates an example of the Web environment information input screen. The Web environment information input screen 730 is provided with a port number input part 731, a Web administrator's contact address input part 732, a document root input part 733, a Back button 734, and a Next button 735.

The port number input part 731 is a textbox in which is set the port number of a TCP port used for the Web server communications. In the example of FIG. 14, “80” is set in the port number input part 731.

The Web administrator's contact address input part 732 is a textbox in which is set the contact address (usually, electronic mail address) of the Web server administrator. In the example shown in FIG. 14, “root@testA.co.jp” is set in the Web administrator's contact address input part 732.

The document root input part 733 is a textbox for the entry of the name of the highest location (directory) in the hierarchical directory structure of the group of contents to be opened to the public. In the example of FIG. 14, “public_html” is set in the document root input part 733.

The Back button 734 is used to reserve the settings in the Web environment information input screen 730 and to switch the screen to the previous screen (environment setting basic information input screen 720). If the Back button 734 is pressed, the screen of the training terminal 210 switches to the environment setting basic information input screen 720, without the Web environment information being transmitted to the seminar server computer 100.

The Next button 735 is used to determine the settings in the Web environment information input screen 730 and to transmit the Web environment information to the seminar server computer 100. If the Next button 735 is pressed, Web environment information is generated in accordance with the contents of data input in the Web environment information input screen 730 and transmitted to the seminar server computer 100.

On receiving the Web environment information, the seminar server computer 100 then transmits the proxy environment information input screen data to the training terminal 210, whereupon the proxy environment information input screen is displayed at the training terminal 210.

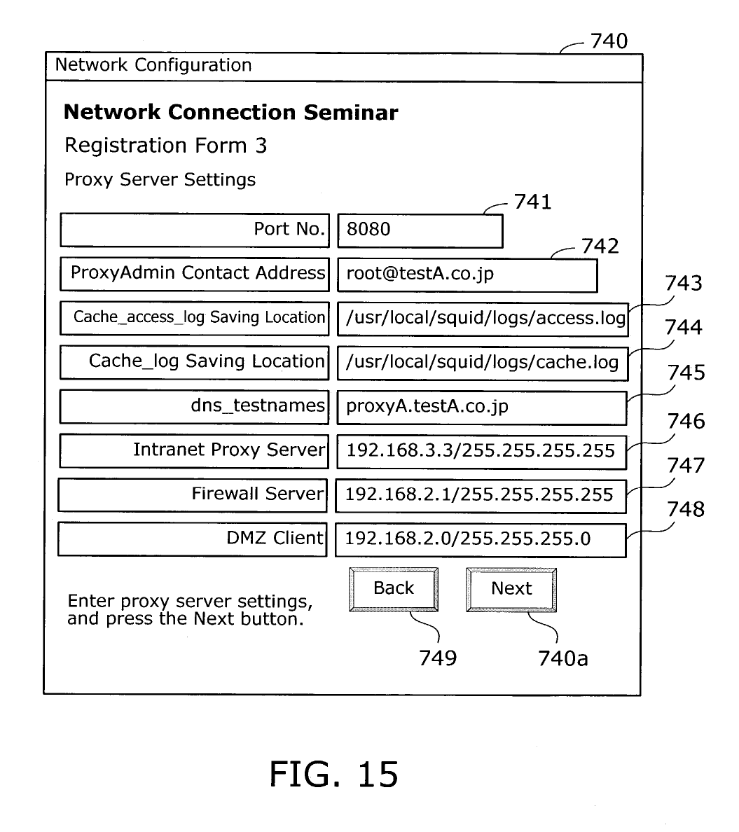

FIG. 15 illustrates an example of the proxy environment information input screen. The proxy environment information input screen 740 is provided with a port number input part 741, a proxy administrator's contact address input part 742, a cache access log saving location input part 743, a cache log saving location input part 744, a DNS test name input part 745, an intranet proxy server designation input part 746, an intranet firewall server designation input part 747, a DMZ (DeMilitarized Zone) client designation input part 748, a Back button 749, and a Next button 740a.

The port number input part 741 is a textbox in which is set the port number of a TCP port used for the proxy server communications. In the example of FIG. 15, “8080” is set in the port number input part 741.

The proxy administrator's contact address input part 742 is a textbox in which is set the contact address (usually, electronic mail address) of the proxy server administrator. In the example shown in FIG. 15, “root@testA.co.jp” is set in the proxy administrator's contact address input part 742.

The cache access log saving location input part 743 is a textbox in which is specified a directory for recording connection requests. In the example of FIG. 15, “/usr/local/squid/logs/access.log” is set in the cache access log saving location input part 743.

The cache log saving location input part 744 is a textbox in which is specified a directory for recording the state of the proxy server. In the example of FIG. 15, “/usr/local/squid/logs/cache.log” is set in the cache log saving location input part 744.

The DNS test name input part 745 is a textbox in which is set the host to which a test inquiry is sent when a DNS inquiry is tested. In the example shown in FIG. 15, “proxyA.testA.co.jp” is set in the DNS test name input part 745.

The intranet proxy server designation input part 746 is a textbox in which is set the IP address of the proxy server on the intranet. In the example shown in FIG. 15, “192.168.3.3/255.255.255.255” is set in the intranet proxy server designation input part 746.

The intranet firewall server designation input part 747 is a textbox in which is set the IP address of the firewall server on the intranet. In the example of FIG. 15, “192.168.2.1/255.255.255.255” is set in the intranet firewall server designation input part 747.

The DMZ client designation input part 748 is a textbox in which is set the IP address of the client in the DMZ. In the example of FIG. 15, “192.168.2.0/255.255.255.0” is set in the DMZ client designation input part 748.

The Back button 749 is used to reserve the settings in the proxy environment information input screen 740 and to switch the screen to the previous screen (Web environment information input screen 730). If the Back button 749 is pressed, the screen of the training terminal 210 switches to the Web environment information input screen 730, without the proxy environment information being transmitted to the seminar server computer 100.

The Next button 740a is used to determine the settings in the proxy environment information input screen 740 and to transmit the proxy environment information to the seminar server computer 100. If the Next button 740a is pressed, proxy environment information is generated in accordance with the contents of data input in the proxy environment information input screen 740 and transmitted to the seminar server computer 100.

On receiving the proxy environment information, the seminar server computer 100 then transmits the DNS environment information input screen data to the training terminal 210, whereupon the DNS environment information input screen is displayed at the training terminal 210.

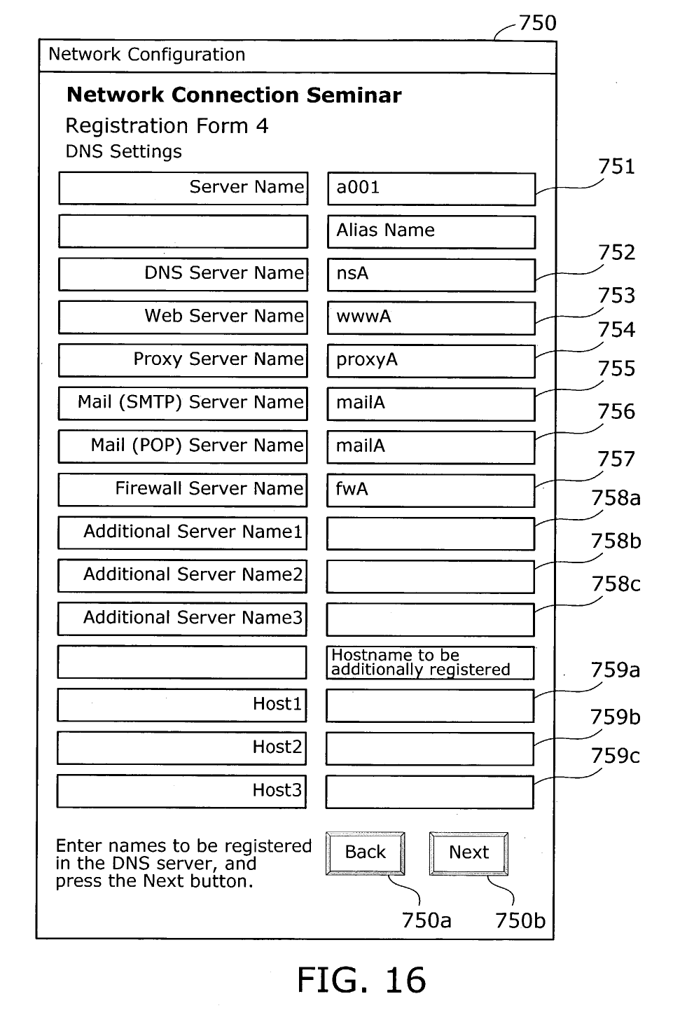

FIG. 16 illustrates an example of the DNS environment information input screen. The DNS environment information input screen 750 is provided with a server name input part 751, a DNS server name input part 752, a Web server name input part 753, a proxy server name input part 754, a mail (SMTP: Simple Mail Transfer Protocol) server name input part 755, a mail (POP: Post Office Protocol) server name input part 756, a firewall server name input part 757, additional server name input parts 758a to 758c, hostname input parts 759a to 759c, a Back button 750a, and a Next button 750b.

The server name input part 751 is a textbox in which is set the name of the server computer where the DNS server function is to be installed. In the example of FIG. 16, “a001” is set in the server name input part 751.

The DNS server name input part 752 is a textbox in which the DNS server name is set. In the example of FIG. 16, “nsA” is set in the DNS server name input part 752.

The Web server name input part 753 is a textbox in which the Web server name is set. In the example of FIG. 16, “wwwA” is set in the Web server name input part 753.

The proxy server name input part 754 is a textbox in which the proxy server name is set. In the example of FIG. 16, “proxyA” is set in the proxy server name input part 754.

The mail (SMTP) server name input part 755 is a textbox in which the SMTP server name is set. In the example of FIG. 16, “mailA” is set in the mail (SMTP) server name input part 755.

The mail (POP) server name input part 756 is a textbox in which the POP server name is set. In the example of FIG. 16, “mailA” is set in the mail (POP) server name input part 756.

The firewall server name input part 757 is a textbox in which the firewall server name is set. In the example of FIG. 16, “fwA” is set in the firewall server name input part 757.

The additional server name input parts 758a to 758c are textboxes in which are specified the names of servers to be set as DNS's other than the above setting.

The hostname input parts 759a to 759c are textboxes in which are set the hostnames of other name servers, if any.

The Back button 750a is used to reserve the settings in the DNS environment information input screen 750 and to switch the screen to the previous screen (proxy environment information input screen 740). If the Back button 750a is pressed, the screen of the training terminal 210 switches to the proxy environment information input screen 740, without the DNS environment information being transmitted to the seminar server computer 100.

The Next button 750b is used to determine the settings in the DNS environment information input screen 750 and to transmit the DNS environment information to the seminar server computer 100. If the Next button 750b is pressed, DNS environment information is generated in accordance with the contents of data input in the DNS environment information input screen 750 and transmitted to the seminar server computer 100.

On receiving the DNS environment information, the seminar server computer 100 transmits the access restriction setting screen data to the training terminal 210, whereupon the access restriction setting screen is displayed at the training terminal 210.

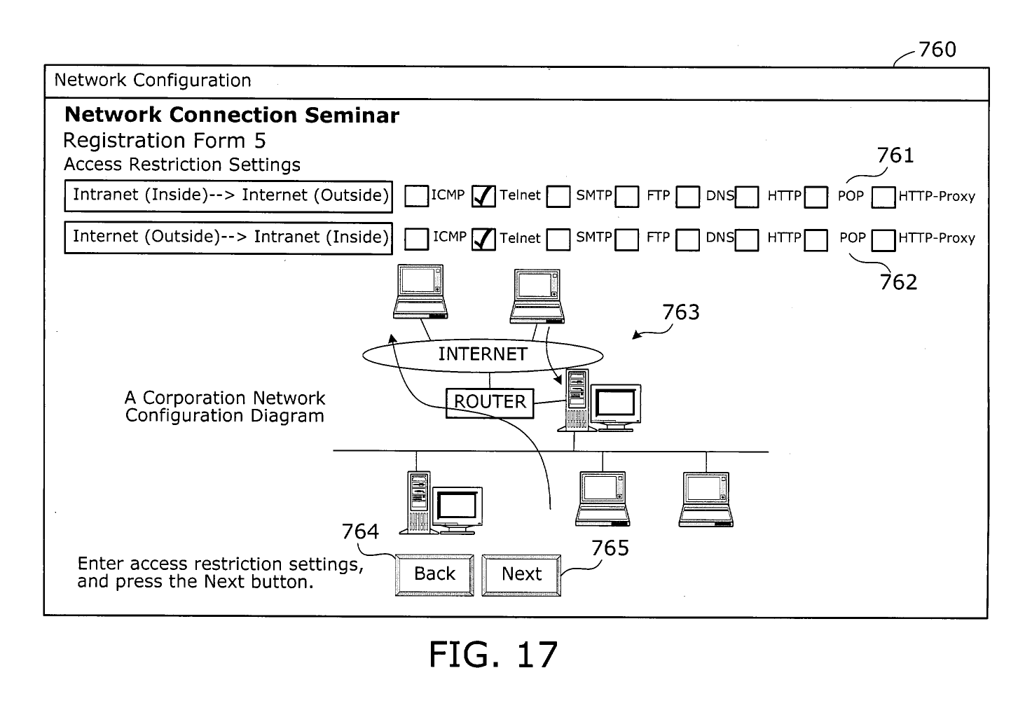

FIG. 17 illustrates an example of the access restriction setting screen. The access restriction setting screen 760 is provided with an inside-to-outside access restriction setting checkbox group 761, an outside-to-inside access restriction setting checkbox group 762, a customer corporation network configuration diagram 763, a Back button 764, and a Next button 765.

The inside-to-outside access restriction setting checkbox group 761 includes a plurality of checkboxes for specifying whether to impose restrictions on the communications from the intranet inside the corporation to the outside Internet. In the example of FIG. 17, checkboxes are provided for ICMP (Internet Control Message Protocol), Telnet, SMTP, FTP, DNS, HTTP, POP, and HTTPProxy. Restriction is imposed on the communication corresponding to the selected checkbox. In the example of FIG. 17, the checkbox for Telnet is selected.

The outside-to-inside access restriction setting checkbox group 762 includes a plurality of checkboxes for specifying whether to impose restrictions on the communications from the Internet outside the corporation to the inside intranet. In the example of FIG. 17, checkboxes are provided for ICMP, Telnet, SMTP, FTP, DNS, HTTP, POP, and HTTP-Proxy. Restriction is imposed on the communication corresponding to the selected checkbox. In the example of FIG. 17, the checkbox for Telnet is selected.

The customer corporation network configuration diagram 763 is a diagram showing the network configuration of the corporation 22 to which the seminar participant belongs. This network configuration diagram 763 is generated by the training curriculum processing section 120 in accordance with the contents of environment information input by the participant. In the network configuration diagram 763, communications free of access restriction are indicated by solid arrows.

The Back button 764 is used to reserve the settings in the access restriction setting screen 760 and to switch the screen to the previous screen (DNS environment information input screen 750). If the Back button 764 is pressed, the screen of the training terminal 210 switches to the DNS environment information input screen 750, without the access restriction setting information being transmitted to the seminar server computer 100.

The Next button 765 is used to determine the settings in the access restriction setting screen 760 and to transmit the access restriction setting information to the seminar server computer 100. If the Next button 765 is pressed, access restriction setting information is generated in accordance with the contents of data input in the access restriction setting screen 760 and transmitted to the seminar server computer 100.

The participants enter the necessary data in the screens explained above, whereupon the individual data input by the respective participants is stored in the blank fields (see FIG. 6) of the training individual environment information table 112 by the training curriculum processing section 120 of the seminar server computer 100.

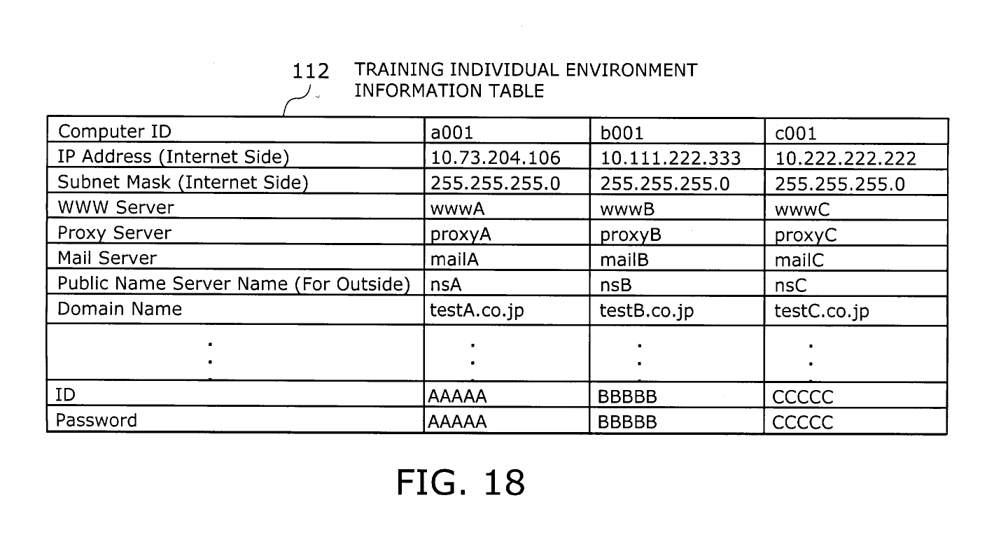

FIG. 18 illustrates an example of the training individual environment information table having such individual data stored therein. In the example of FIG. 18, for the computer ID “a00l” in the training individual environment information table 112, the IP address (Internet side) “10.73.204.106,” subnet mask (Internet side) “255.255.255.0,” WWW server “wwwA,” proxy server “proxyA,” mail server “mailA,” public name server (for outside) “nsA,” domain name “testA.co.jp,” etc. are additionally registered. Similarly, for the computer ID “bool,” the IP address (Internet side) “10.111.222.333,” subnet mask (Internet side) “255.255.255.0,” WWW server “wwwB,” proxy server “proxyB,” mail server “mailB,” public name server (for outside) “nsB,” domain name “testB.co.jp,” etc. are additionally registered. With respect to the computer ID “c001” the IP address (Internet side) “10.222.222.222,” subnet mask (Internet side) “255.255.255.0,” WWW server “wwwC,” proxy server “proxyC,” mail server “mailC,” public name server (for outside) “nsC,” domain name “testC.co.jp,” etc. are additionally registered.

After the training individual environment information table 112 is created in this manner, the environment information processing section 130 generates the user-specific environment setting table 113. The user-specific environment setting table 113 is generated in compliance with the table item linkage rules 131 (shown in FIG. 7).

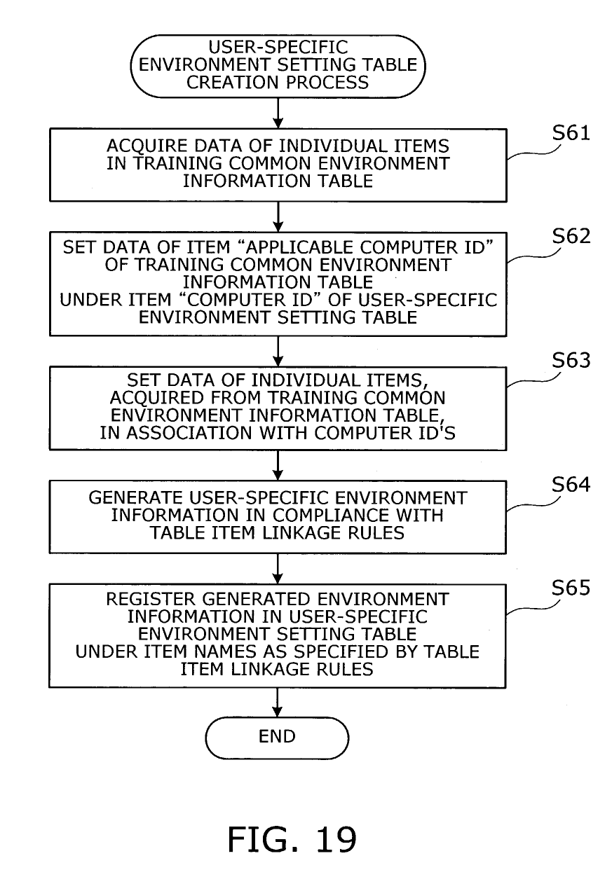

FIG. 19 is a flowchart illustrating the procedure for a user-specific environment setting table creation process. In the following, the process shown in FIG. 19 will be explained in order of step number.

[Step S61] The environment information processing section 130 acquires data in the individual items of the training common environment information table 111.

[Step S62] The environment information processing section 130 registers the individual computer IDs, which are set as the item “Applicable Computer ID” in the training common environment information table 111, under the item “Computer ID” of the user-specific environment setting table 113 as discrete data. If the training common environment information table 111 has the contents as shown in the example of FIG. 5, the user-specific environment setting table 113 is set with data “a001,” “b001” and “c001” under the item “Computer ID.”

[Step S63] The environment information processing section 130 sets data in the individual items acquired from the training common environment information table 111 in association with each of the computer IDs set under the item “Computer ID.”

[Step S64] In compliance with the table item linkage rules 131, the environment information processing section 130 generates user-specific environment information based on the training individual environment information table 112.

[Step S65] The environment information processing section 130 additionally registers the thus-generated environment information in the user-specific environment setting table 113 under the items as specified by the table item linkage rules 131.

In this manner, the user-specific environment setting table 113 is created. The following is a detailed description of an exemplary process (inter-table item linkage process) for generating environment information based on the training individual environment information table 112 and additionally registering the generated information in the user-specific environment setting table 113 in compliance with the table item linkage rules 131.

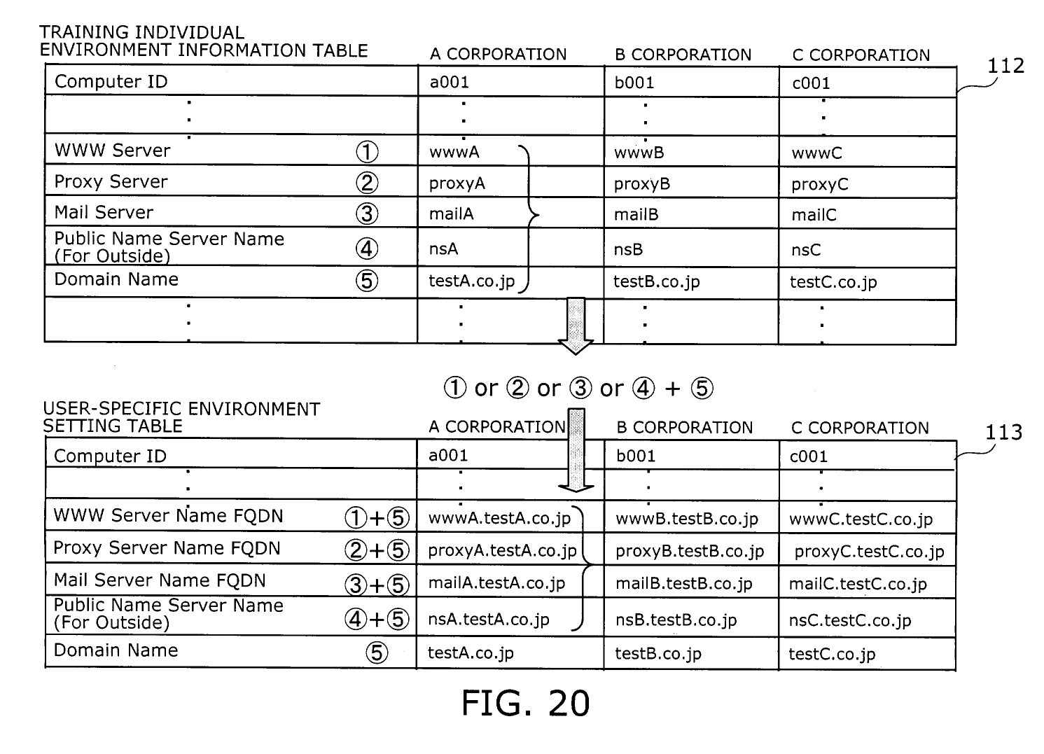

FIG. 20 is a conceptual diagram illustrating an example of the inter-table item linkage process. The example of FIG. 20 shows the inter-table item linkage process carried out in compliance with the table item linkage rules 131 shown in FIG. 7.

The table item linkage rules 131 specify, as the items to be additionally registered in the user-specific environment setting table 113, “WWW Server Name FQDN,” “Proxy Server Name FQDN,” “Mail Server Name FQDN,” “Public Name Server Name (For Outside),” “Domain Name,” etc. Accordingly, the environment information processing section 130 newly adds these items to the user-specific environment setting table 113.

Then, the environment information processing section 130 generates data for each of the added items of the respective computer IDs in compliance with the table item linkage rules 131. As a result, for the “WWW Server Name FQDN” under the computer ID “a001,” “wwwA.testa.co.jp” is set which is the combination “WWW Server”+“Domain Name” in the training individual environment information table 112. For the “Proxy Server Name FQDN” under the computer ID “a001,” “proxyA.testA.co.jp” is set which is the combination “Proxy Server”+“Domain Name” in the training individual environment information table 112. For the “Mail Server Name FQDN” under the computer ID “a001,” “mailA.testa.co.jp” is set which is the combination “Mail Server”+“Domain Name” in the training individual environment information table 112. For the “Public Name Server Name (For Outside)” under the computer ID “a001,” “nsA.testa.co.jp” is set which is the combination “Public Name Server Name (For Outside)”+“Domain Name” in the training individual environment information table 112. For the “Domain Name” under the computer ID “a001,” “testA.co.jp” is set which is the “Domain Name” in the training individual environment information table 112.

Similarly, data is registered with respect to the other computer IDs “b001” and “c001.” Specifically, with respect to the computer ID “b001,” “wwwB.testB.co.jp” is set for the “WWW Server Name FQDN,” “proxyB.testB.co.jp” for the “Proxy Server Name FQDN,” “mailB.testB.co.jp” for the “Mail Server Name FQDN,” “nsB.testB.co.jp” for the “Public Name Server Name (For Outside),” and “testB.co.jp” for the “Domain Name.” With respect to the computer ID “c001,” “wwwC.testC.co.jp” is set for the “WWW Server Name FQDN,” “proxyC.testC.co.jp” for the “Proxy Server Name FQDN,” “mailC.testC.co.jp” for the “Mail Server Name FQDN,” “nsC.testC.co.jp” for the “Public Name Server Name (For Outside),” and “testC.co.jp” for the “Domain Name.”

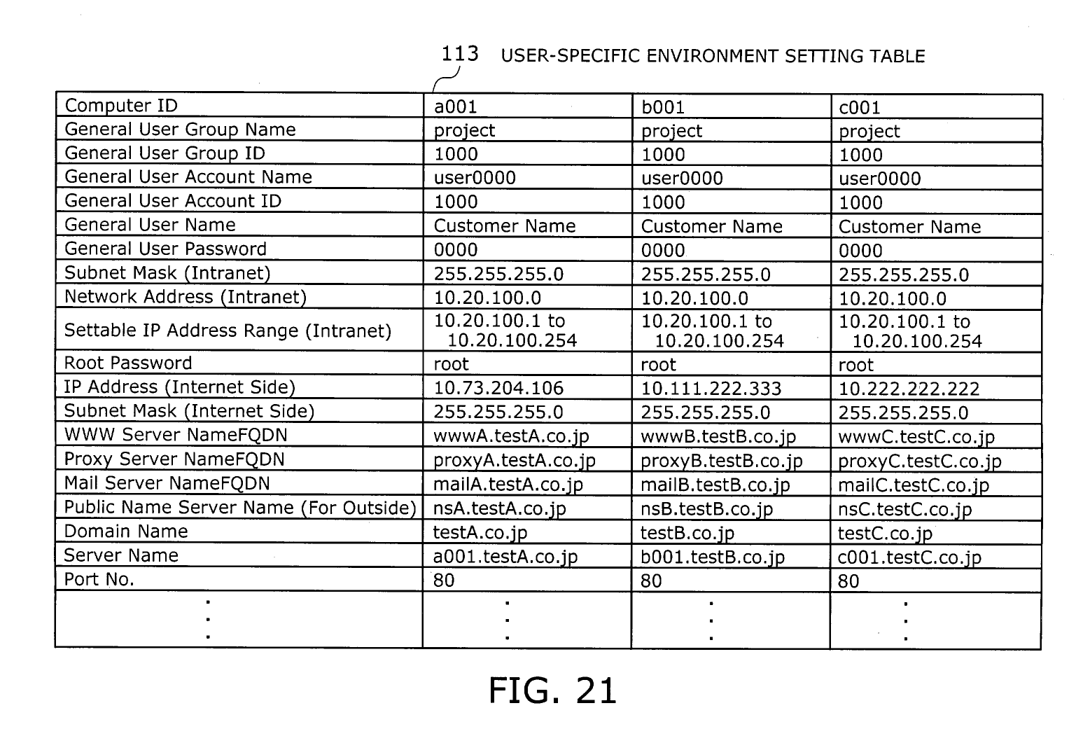

FIG. 21 illustrates an exemplary data structure of the user-specific environment setting table. As the contents of the user-specific environment setting table 113, user-specific environment information is set for each of the computer IDs set under the item “Computer ID.” The environment information thus set can be classified into items transferred from the training common environment information table 111 and items generated in compliance with the table item linkage rules 131.

In FIG. 21, items from “General User Group Name” through “Subnet Mask (Internet Side)” are the items transferred from the training common environment information table 111, and the item “WWW Server Name FQDN” and the following items are the items generated in compliance with the table item linkage rules 131.

After the user-specific environment setting table 113 is generated, the system configuration information processing section 140 generates system configuration information specific to each of the computer IDs.

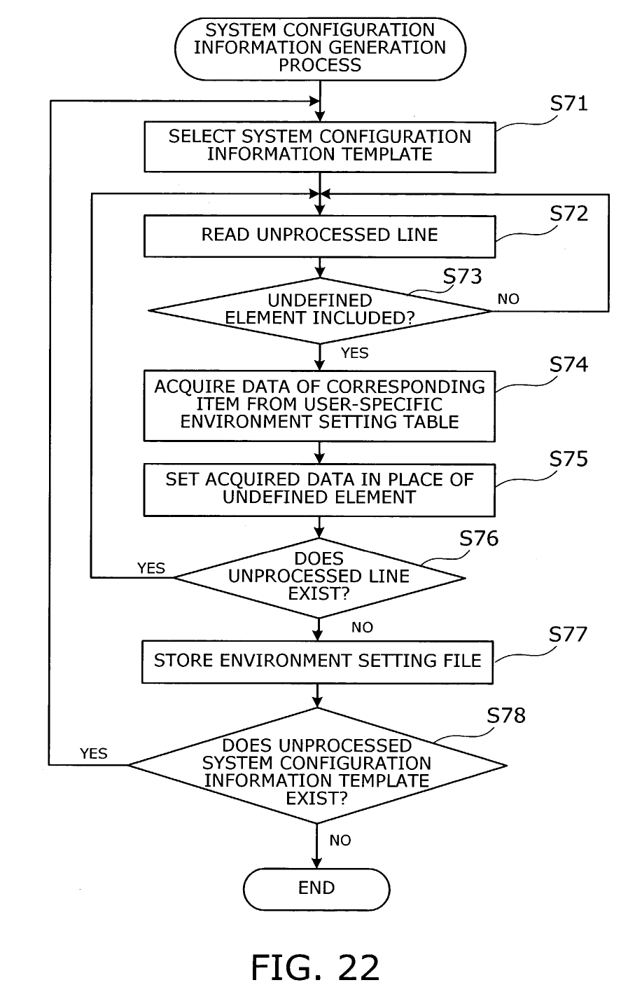

FIG. 22 is a flowchart illustrating the procedure for a system configuration information generation process. The process shown in FIG. 22 will be now explained in order of step number. In the process described below, only the templates corresponding to servers (Web server etc.) to be configured are used.

[Step S71] The system configuration information processing section 140 selects one of the templates prepared as the system configuration information templates 141.

[Step S72] The system configuration information processing section 140 reads in an unprocessed line from the top of the selected template.

[Step S73] The system configuration information processing section 140 determines whether or not the read line includes an undefined element. If an undefined element is included, the process proceeds to Step S74. If there is no undefined element for which no data has been set, the initial state (default) described in the line is maintained, and the process proceeds to Step S72.

[Step S74] The system configuration information processing section 140 selects one undefined element in the template and acquires data corresponding to the item name of the undefined element from the user-specific environment setting table 113.

[Step S75] The system configuration information processing section 140 sets the acquired data in the location of the selected undefined element.

[Step S76] The system configuration information processing section 140 determines whether or not there is an unprocessed line in the template selected in Step S71. If there is an unprocessed line, the process proceeds to Step S72; if all the lines have been processed, the process proceeds to Step S77.

[Step S77] The system configuration information processing section 140 stores the environment setting file, which has been generated by executing Steps S72 to S76 on the basis of the template selected in Step S71, in the computer ID-specific system configuration information 114.

[Step S78] The system configuration information processing section 140 determines whether or not there is an unprocessed template among the templates prepared as the system configuration information templates 141. If there is an unprocessed template, the process proceeds to Step S71; if there is no unprocessed template, the system configuration information generation process is ended.

In this manner, the computer ID-specific system configuration information 114 is generated.

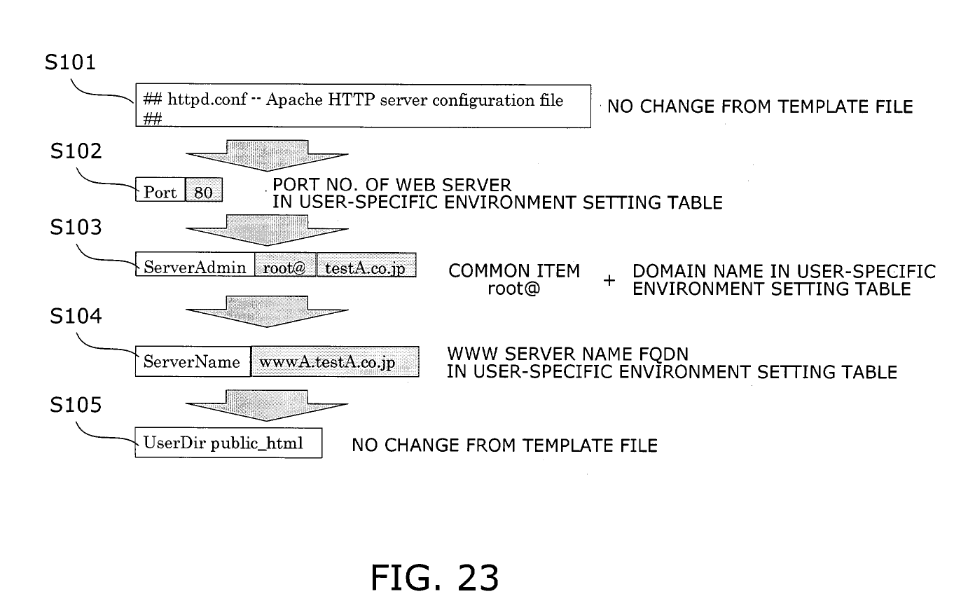

FIG. 23 is a conceptual diagram illustrating an exemplary process for generating an environment setting file for the Web server. The Web server environment setting file is generated on the model of the Web server setting template 141a shown in FIG. 8.

First, the first and second lines of the Web server setting template 141a are sequentially read. Since these lines include no undefined element, no change is made to the content (default) described in the lines of the Web server setting template 141a (Step S101).

The third line is then read. Since this line includes an undefined element, the undefined element is replaced by the value “80” of the item “Port No.” in the user-specific environment setting table 113 (Step S102).

Subsequently, the fourth line is read. This line also includes an undefined element, and accordingly, the undefined element is replaced by the common item “root@” plus the value “testA.co.jp” of the item “Domain Name” in the user-specific environment setting table 113 (Step S103).

Then, the fifth line is read. Since this line includes an undefined element, the undefined element is replaced by the value “wwwA.testa.co.jp” of the item “WWW Server Name FQDN” in the user-specific environment setting table 113 (Step S104).

The sixth line read next includes no undefined element, and accordingly, no change is made to the content (default) described in this line of the Web server setting template 141a (Step S105).

In this manner, the undefined elements are replaced line by line, so that the Web server environment setting file (Web server setting file) is generated. A similar process is performed also with respect to the other templates, to generate environment setting files necessary for the respective servers to be configured.

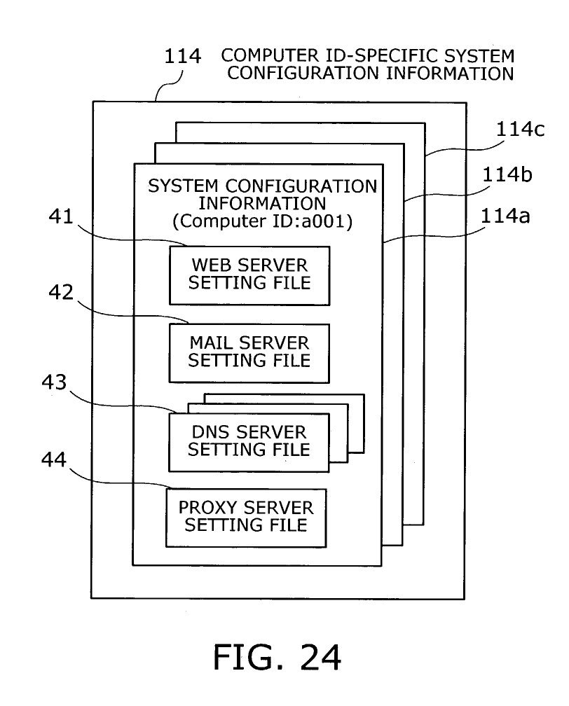

FIG. 24 illustrates an exemplary data structure of the computer ID-specific system configuration information. The computer ID-specific system configuration information 114 has stored therein system configuration information 114a, 114b, 114c specific to the respective computer IDs. Each system configuration information 114a, 114b, 114c includes at least one environment setting file.

For example, the system configuration information 114a associated with the computer ID “a001” includes a Web server setting file 41, a mail server setting file 42, a plurality of DNS server setting files 43, and a proxy server setting file 44.

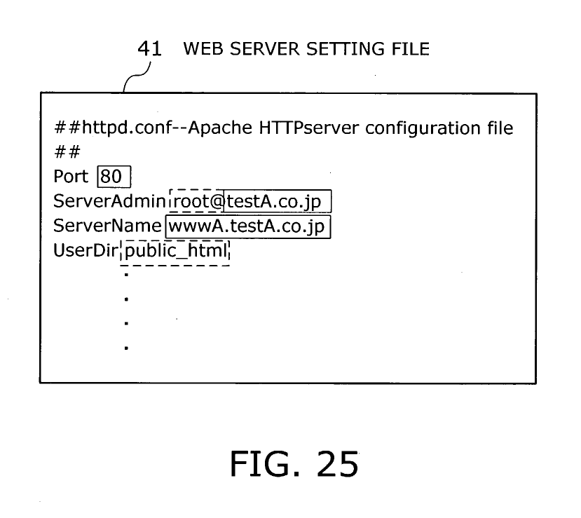

Specific examples of the various environment setting files will be now described with reference to FIGS. 25 to 30. In the environment setting files described below, those values which are set in common in the environment setting files for all seminar participants (all computer IDs) are enclosed by the dashed line, and those values which are set discretely for the individual seminar participants (individual computer IDs) are enclosed by the solid line. Further, it should be noted that FIGS. 25 to 30 illustrate only parts of the respective exemplary environment setting files, and not the whole of the environment setting files associated with the respective servers.

FIG. 25 illustrates an example of the Web server setting file. For the port number (Port) in the Web server setting file 41, for example, the value “80” of the item “Port No.” in the user-specific environment setting table 113 is set. For the server administrator's contact address is set the common value “root@” followed by the value “testA.co.jp” of the item “Domain Name” in the user-specific environment setting table 113. For the server name is set the value “wwwA.testA.co.jp” of the item “WWW Server Name FQDN” in the user-specific environment setting table 113.

The Web server setting file 41 having such contents is stored in a predetermined location of the server computer 510, whereby a Web server matching the existing network environment of the corporation 22 can be configured.

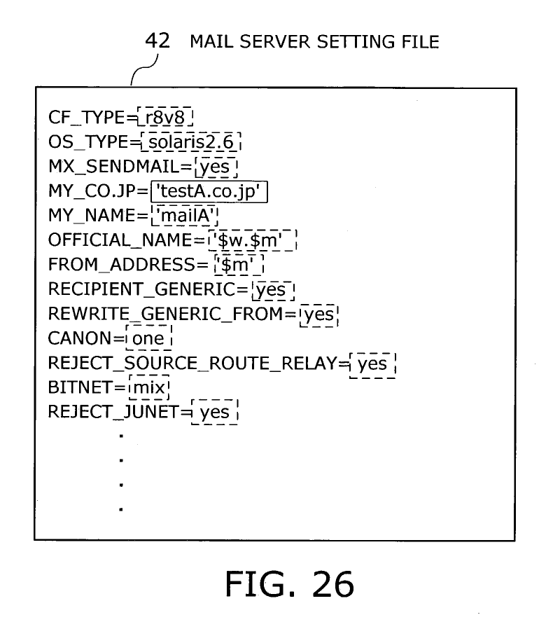

FIG. 26 illustrates an example of the mail server setting file. The mail server setting file 42 having such contents as illustrated in FIG. 26 is stored in a predetermined location of the server computer 510, whereby a mail server matching the existing network environment of the corporation 22 can be configured.

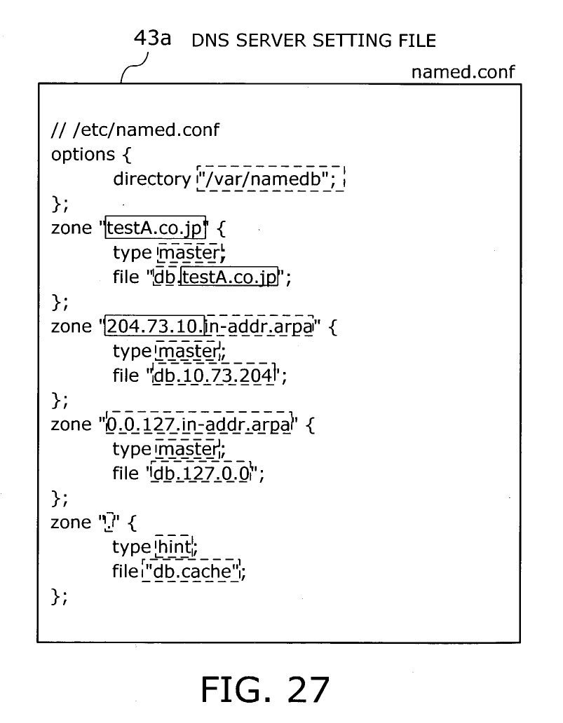

FIG. 27 illustrates a first example of the DNS server setting file. This DNS server setting file 43a is stored in the server computer 510 with the filename “named.conf” assigned thereto.

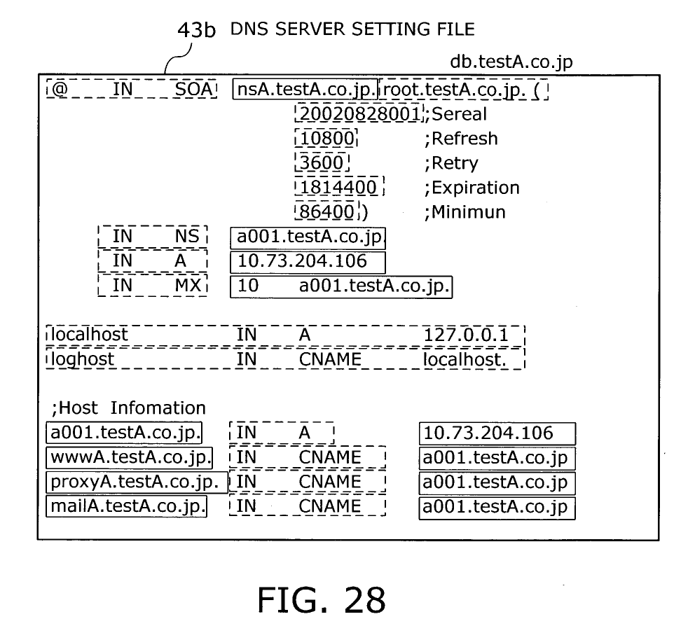

FIG. 28 illustrates a second example of the DNS server setting file. This DNS server setting file 43b is stored in the server computer 510 with the filename “db.testA.co.jp” assigned thereto.

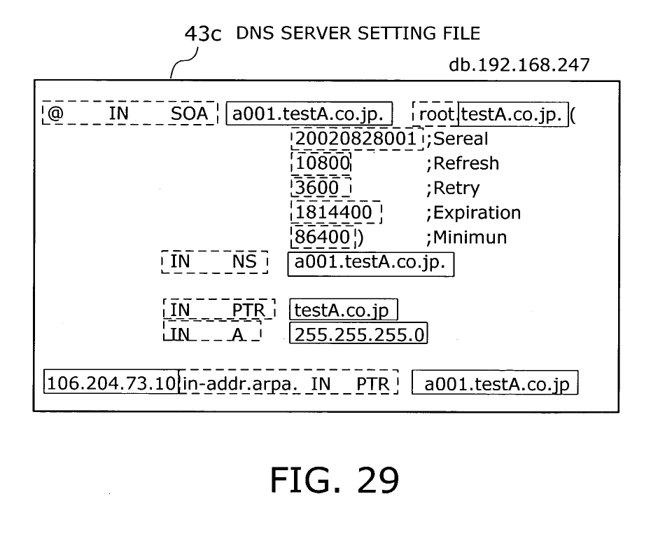

FIG. 29 illustrates a third example of the DNS server setting file. This DNS server setting file 43c is stored in the server computer 510 with the filename “db.192.168.247” assigned thereto.

The DNS server setting files 43a, 43b and 43c shown in FIGS. 27 to 29 are stored in predetermined locations of the server computer 510, whereby a DNS server matching the existing network environment of the corporation 22 can be configured.

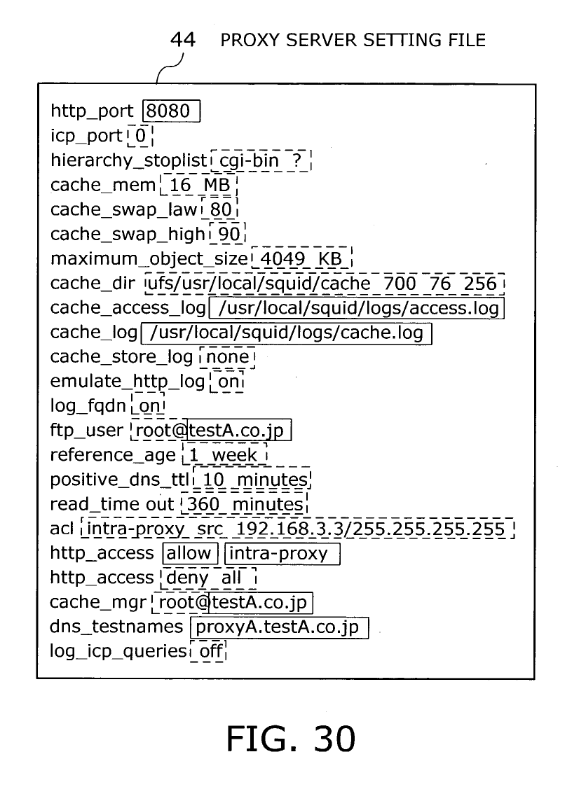

FIG. 30 illustrates an example of the proxy server setting file. The proxy server setting file 44 having such contents as illustrated in FIG. 30 is stored in a predetermined location of the server computer 510, whereby a proxy server matching the existing network environment of the corporation 22 can be configured.

After the various servers are configured in the server computer 510, the seminar participant can perform remote access to the server computer 510 and can confirm the operation of the installed servers by using the training terminal 210.

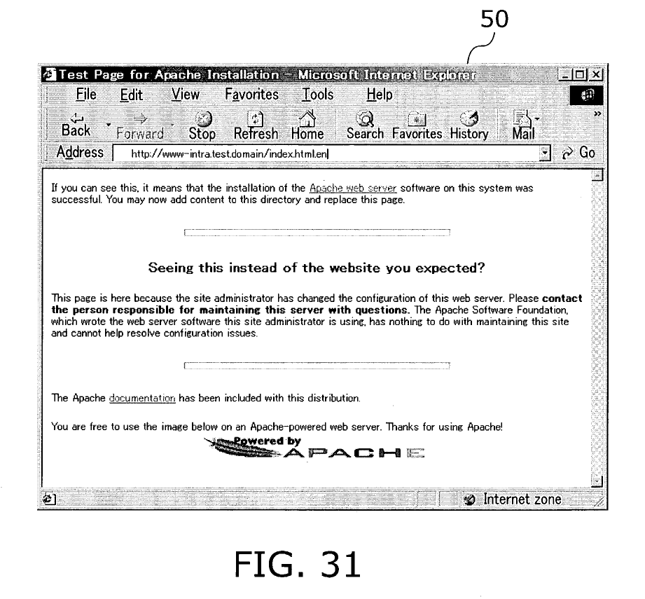

FIG. 31 illustrates an example of a Web server startup screen. In the example of FIG. 31, a browser is started on the training terminal 210 and the operation of the Web server configured in the server computer 510 is confirmed through the browser.

In this manner, the participant can configure various servers on the network of his/her corporation and confirm the operation of the servers from the seminar site. In the event the participant has trouble, he/she can ask the instructor on the spot for solution, so that the trouble can be remedied quickly.

Further, servers can be installed on the network of the participant's corporation during the term of the seminar, and it is therefore unnecessary for the participant to again configure the system after returning to his/her corporation following the seminar, thus permitting efficient administration of the corporate network.

In the case of collectively installing a plurality of network applications (Web server, mail server, etc.), moreover, environment information (server IP addresses etc.) that is used in common among the applications needs to be entered, but according to this embodiment, one set of environment information has to be input only once to create a plurality of environment setting files for the respective network applications. Namely, it is unnecessary to enter the environment information repeatedly when installing a plurality of network applications, thereby simplifying the environment setting operation at the time of installation.

Also, when the seminar participant enters settings, a diagram showing the existing network configuration of the participant's corporation is displayed on the screen of the training terminal. This permits the participant to input necessary information while confirming the network configuration of his/her corporation on the diagram.

In the above description, the example of displaying a screen including a network configuration diagram is explained as an example of generating a settings-specific input screen based on the environment information entered in the previously displayed settings-specific input screen and displaying the generated screen on the training terminal. It is also possible to generate various other objects or information based on the previously input environment information.

Also, in the above description, the participants themselves go to the place where the seminar arranged by the training corporation 21 is held, to receive the seminar. Alternatively, a videoconferencing system, video phones or the like may be used so that participants can receive the seminar while staying at their corporations. In such cases, the server computer or other terminal in the corporation is used as the training terminal.

Although the foregoing description is directed to the exemplary case where a network application such as a Web server is installed in the network environment of the participant's corporation as part of the training conducted in the seminar, the techniques of the present invention can be applied to other situations than seminars. For example, the present invention is applicable to the case of supporting the maintenance and management of networks from a remote place. In this case, the operator who has been provided with information on an existing network environment from a customer inputs, through a terminal device, the environment information to an application installation support device having the same function as the aforementioned seminar server, whereupon the application installation support device accesses the server on the customer's network and stores application-related individual environment setting information in the server. This facilitates the maintenance and management of the network environment from a remote place.

Further, the processing functions described above can be performed by a server computer and a client computer. In this case, a server program is provided in which is described a process for performing the functions of the seminar server computer, and also a client program is provided in which is described a process for performing the functions of the training terminal. The server program is executed by the server computer, whereby the processing functions of the seminar server computer can be accomplished by the server computer. Also, the client program is executed by the client computer, whereby the processing functions of the training terminal can be accomplished by the client computer.

The server and client programs describing the processes may be recorded on a computer-readable recording medium. The computer-readable recording medium includes magnetic recording device, optical disc, magneto-optical recording medium, semiconductor memory, etc. Such a magnetic recording device may be hard disk drive (HDD), flexible disk (FD), magnetic tape, etc. As the optical disc, DVD (Digital Versatile Disc), DVD-RAM (Random Access Memory), CD-ROM (Compact Disc Read Only Memory), CD-R (Recordable)/RW (ReWritable) or the like may be used. The magneto-optical recording medium includes MO (Magneto-Optical disc) etc.

To distribute the server or client program, portable recording media, such as DVD and CD-ROM, on which the program is recorded may be put on sale. Also, the client program may be stored in the storage device of the server computer and may be transferred from the server computer to client computers through a network.

The server computer which is to execute the server program stores, in its storage device, the server program recorded on a portable recording medium, for example. The server computer loads the server program from its storage device and performs processing in accordance with the server program. Alternatively, the server computer may read in the server program directly from the portable recording medium to perform processing in accordance with the server program.

The client computer which is to execute the client program stores, in its storage device, the client program recorded on a portable recording medium or transferred from the server computer, for example. The client computer loads the client program from its storage device and performs processing in accordance with the client program. Alternatively, the client computer may read in the client program directly from the portable recording medium to perform processing in accordance with the client program. Further, as the client program is transferred from the server computer, the client computer may sequentially perform processing in accordance with the client program.

As described above, according to the present invention, environment information input to the terminal devices by participants is acquired and individual environment setting information necessary for configuring a network application to be installed is generated based on the acquired environment information. Accordingly, the individual environment setting information for configuring the network application in the network environments of the respective participants' corporations can be created in the course of the training conducted in the seminar. The generated individual environment setting information may be stored in the server computer of the respective corporate network, whereupon the environment for the network application can be configured in the server computer. This makes it unnecessary for the individual participants to again follow the procedure for configuring the environment after returning to their corporations, thus saving the time and labor for the configuration of the network application.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A training support program for supporting training conducted in a network application installation seminar, wherein the training support program causes a computer to perform a process of:
causing a terminal device used by a participant in the seminar to display, in accordance with progress of the seminar, an input screen for entering environment information matching an environment of a network in which the participant intends to install the network application; and
acquiring the environment information entered by the participant into the terminal device following a training procedure of the seminar, to generate, based on the acquired environment information, individual environment setting information necessary for configuring an operational environment for the network application on the network.

2. The training support program according to claim 1, wherein the training support program further causes the computer to perform a process of accessing, through a different network, a server computer in the network in which the participant intends to install the network application, to store the individual environment setting information in the server computer.

3. The training support program according to claim 2, wherein, when the individual environment setting information is to be stored in the server computer, the training support program causes the computer to perform a process of generating an environment setting file including the individual environment setting information and storing the generated environment setting file in the server computer.

4. The training support program according to claim 3, wherein the environment setting file is generated by inserting the individual environment setting information into a template which is prepared beforehand for a file in which the environment information for the network application is to be set.

5. The training support program according to claim 1, wherein the input screen includes a plurality of settings-specific input screens prepared according to the training procedure, and when the input screen is to be displayed, the training support program causes the computer to perform a process of generating a settings-specific input screen based on the environment information entered in a previously displayed settings-specific input screen and displaying the generated settings-specific input screen at the training terminal.

6. The training support program according to claim 5, wherein, when the settings-specific input screen is to be generated, the training support program causes the computer to perform a process of generating a screen including a diagram of an existing configuration of the network in accordance with the environment information entered in the previously displayed settings-specific input screen.

7. The training support program according to claim 1, wherein, when the individual environment setting information is to be generated, the training support program causes the computer to perform a process of combining common environment information common to all participants with the environment information entered by the participant, in compliance with predetermined linkage rules, to generate the individual environment setting information.

8. An application installation support program for installing a network application from a remote place, wherein the application installation support program causes a computer to perform a process of:
causing a terminal device to display an input screen for entering environment information matching an environment of a network in which the network application is to be installed;
acquiring the environment information entered into the terminal device to generate, based on the acquired environment information, individual environment setting information necessary for configuring an operational environment for the network application on the network; and
accessing, through a different network, a server computer in the network in which the network application is to be installed, to store the individual environment setting information in the server computer.

9. A training support method for supporting training conducted in a network application installation seminar with use of a computer, comprising:
causing a terminal device used by a participant in the seminar to display, in accordance with progress of the seminar, an input screen for entering environment information matching an environment of a network in which the participant intends to install the network application; and
acquiring the environment information entered by the participant into the terminal device following a training procedure of the seminar, to generate, based on the acquired environment information, individual environment setting information necessary for configuring an operational environment for the network application on the network.

10. An application installation support method for installing a network application from a remote place with use of a computer, comprising:
causing a terminal device to display an input screen for entering environment information matching an environment of a network in which the network application is to be installed;
acquiring the environment information entered into the terminal device to generate, based on the acquired environment information, individual environment setting information necessary for configuring an operational environment for the network application on the network; and
accessing, through a different network, a server computer in the network in which the network application is to be installed, to store the individual environment setting information in the server computer.

11. A training support device for supporting training conducted in a network application installation seminar, comprising:
input screen display means for causing a terminal device used by a participant in the seminar to display, in accordance with progress of the seminar, an input screen for entering environment information matching an environment of a network in which the participant intends to install the network application; and
individual environment setting information generation means for acquiring the environment information entered by the participant into the terminal device following a training procedure of the seminar, to generate, based on the acquired environment information, individual environment setting information necessary for configuring an operational environment for the network application on the network.

12. An application installation support device for installing a network application from a remote place, comprising:
input screen display means for causing a terminal device to display an input screen for entering environment information matching an environment of a network in which the network application is to be installed;
individual environment setting information generation means for acquiring the environment information entered into the terminal device to generate, based on the acquired environment information, individual environment setting information necessary for configuring an operational environment for the network application on the network; and
individual environment setting information storage means for accessing, through a different network, a server computer in the network in which the network application is to be installed, to store the individual environment setting information in the server computer.

13. A computer-readable recording medium having a training support program recorded thereon for supporting training conducted in a network application installation seminar, wherein the training support program causes the computer to perform a process of:
causing a terminal device used by a participant in the seminar to display, in accordance with progress of the seminar, an input screen for entering environment information matching an environment of a network in which the participant intends to install the network application; and
acquiring the environment information entered by the participant into the terminal device following a training procedure of the seminar, to generate, based on the acquired environment information, individual environment setting information necessary for configuring an operational environment for the network application on the network.

14. A computer-readable recording medium having an application installation support program recorded thereon for installing a network application from a remote place, wherein the application installation support program causes the computer to perform a process of:
causing a terminal device to display an input screen for entering environment information matching an environment of a network in which the network application is to be installed;
acquiring the environment information entered into the terminal device to generate, based on the acquired environment information, individual environment setting information necessary for configuring an operational environment for the network application on the network; and
accessing, through a different network, a server computer in the network in which the network application is to be installed, to store the individual environment setting information in the server computer.
